(19) United States
(12) Patent Application Publication
(10) Pub. No.: US 2002/0037824 A1
(43) Pub. Date: Mar. 28, 2002

(54) Detergent compositions comprising a maltogenic alpha-amylase enzyme and a detergent ingredient

(75) Inventors: Johan Smets, Lubbeek (BE); An Pintens, Merksem (BE)

Correspondence Address: THE PROCTER & GAMBLE COMPANY, PATENT DIVISION, IVORYDALE TECHNICAL CENTER - BOX 474, 5299 SPRING GROVE AVENUE, CINCINNATI, OH, 45217, US

(73) Assignee: The Procter & Gamble Company

(21) Appl. No.: 09/888,758

(22) Filed: Jun. 25, 2001

(30) Foreign Application Priority Data
Jun. 30, 2000 (US) PCT/US00/18120

(51) Int. Cl. C11D 3/00; C11D 7/18; C11D 9/42; C11D 7/42; C12S 9/00

(52) U.S. Cl. 510/305; 510/306; 510/313; 510/392

(57) ABSTRACT

The present invention relates to detergent compositions, including laundry, dishwashing, and/or hard surface cleaner compositions, comprising a maltogenic alpha-amylase enzyme and a detergent ingredient selected from the group consisting of a nonionic surfactant, a protease, a bleaching agent and/or mixtures thereof. Such compositions provide excellent removal of starch-containing stains and soils, and when formulated as laundry compositions, excellent whiteness maintenance and dingy cleaning.

### FIELD OF THE INVENTION

The present invention relates to detergent compositions comprising a maltogenic alpha-amylase enzyme and a detergent ingredient selected from a nonionic surfactant, a protease enzyme and/or a bleaching agent.

### BACKGROUND OF THE INVENTION

Performance of a detergent product is judged by a number of factors, including the ability to remove soils. Therefore, detergent components such as surfactants, bleaching agents and enzymes, have been incorporated in detergents. One of such specific example is the use of proteases, lipases, amylases and/or cellulases.

In particular, amylase enzymes have long been recognised in detergent compositions to provide the removal of starchy food residues or starchy films from dishware or hard surfaces or to provide cleaning performance on starchy soils as well as other soils typically encountered in laundry and dishwashing applications. Indeed, starchy materials such as amylose and amylopectin, constitute one of the major components of the soils/stains encountered in laundry, dishwashing or hard surfaces cleaning operations. Moreover, the textile industry uses starchy materials in their textile finishing processes. Therefore, amylase enzymes have been since a long time incorporated into the detergent products for the removal of starch-containing stains. However, it has been surprisingly found that such commonly used detergent amylases could not hydrolyse retrograded starch or raw starch.

As studied in J. A. Radley “Starch and its Derivatives” Fourth Edition Chapman and Hall Ltd p194-201; retrogradation is a term given to the changes which occur spontaneously in a starch paste, or gel on ageing. It arises from the inherent tendency of starch molecules to bind to one another and which leads to an increase in crystallinity. Solutions of low concentration become increasingly cloudy due to the progressive association of starch molecules into larger particles. Spontaneous precipitation takes place and the precipitated starch appears to be reverting to its original condition of cold-water insolubility. Pastes of higher concentration on cooling set to a gel, which on ageing becomes steadily firmer due to the increasing association of the starch molecules. This arises because of the strong tendency for hydrogen bond formation between hydroxy groups on adjacent starch molecules.

The changes taking place during retrogradation are of considerable importance in the industrial uses of starch. It is believed to be an important factor in the staling of bread and in the textural changes of other starch-containing foods, e.g. canned soups, peas, meat preparations, etc. Starch and retrograded starch are also found in the textile, paper and adhesives industries. Indeed, fabrics are sized with starch in the textile process. Depending on the sizing process, retrograded starch can be formed on the fabrics and might not be removed in the ulterior desizing processes. Moreover, the majority of the stains/soils found on fabrics, dishware and other hard surfaces, especially those found in the kitchen, contain starch which upon ageing in for e.g., the laundry basket or dishwashing machine will retrograde to such associated starchy network. Hence, such retrograded starch containing materials are found later onto the fabric, dishware and/or other hard surfaces to be cleaned. Such retrograded starch shows an increased resistance to hydrolysis by amylolytic enzymes, is only slightly soluble at ordinary temperatures and redispersed only with difficulty, especially if the retrograded starch has dried first and it further demonstrates a progressive increase in gel firmness. Indeed, it has been found that retrograded starch forms very stable structures and only melts at very high temperature such as 150° C. for amylose, 60° C. for amylopectin or 120° C. for the complex amylose-lipid. The level and timing of retrogradation depends upon the starch type: it can vary from 10% to 90% of the starch content. It has been found that current detergent amylases have very little to no effect on retrograded starch.

In addition, a substantial part of starch material remains indeed under the raw form even when processed within the food or textile industries. In particular, it has been found that food stains such as rice, spaghettis, potatoes, corn, cereals, etc. retrieved on fabric, dishware and other hard surfaces contain a substantial amount of raw starch.

Furthermore, it has been surprisingly found that such retrograded or raw starch remaining on the surfaces, entraps further dirt, and when found on a fabric surface, leads to a dingy appearance of the surface to be cleaned.

As can be seen from the above, there is a need to formulate detergent products which address the removal of such raw or retrograded starch containing soils/stains. Accordingly, the above objective has been met by formulating a detergent composition comprising a maltogenic alpha-amylase enzyme and detergent ingredient selected from a nonionic surfactant, a protease enzyme and/or a bleaching agent.

It has been surprisingly found that the combination of a maltogenic alpha-amylase with a detergent ingredient selected from a nonionic surfactant, a protease enzyme and/or a bleaching agent, provides a synergistic cleaning of starch containing stains and soils. Indeed, it has been found that maltogenic alpha-amylase have an endo-, exo- as well as transferase hydrolytic activity on starch, that can be very useful in a cleaning applications. Moreover, such of starch containing stains and soils comprise many lipids components as well. Without wishing to be bound by theory, it is believed that the nonionic surfactant removes the lipids contained in the starch-containing stains and soils and thereby facilitate the degradation of starch by the maltogenic alpha-amylase. In addition, it is believed that the nonionic surfactant keeps the degraded starch in solution and prevents its redeposition onto the surface to be cleaned. It has been further surprisingly found that nonionic surfactant prevents the retrogradation of starch and therefore is very efficient if used with the maltogenic alpha-amylase in a pre-treatment step. Similarly, such of starch containing stains and soils comprise many proteins components as well. Without wishing to be bound by theory, it is believed that the protease enzyme hydrolyses the proteins contained in such complex stains and thereby induces the synergistic removal of such stains/soils with the maltogenic alpha-amylase. In addition, such hydrolysed proteins/starch containing stains/soils have a lower molecular weight in the wash solution and this results in less redeposition of such hydrolysed stains/soils on the surface to be cleaned. Finally, it has been found that bleaching agents oxidise the starch containing stains and soils. Without wishing to be bound by theory it is believed that the oxidising action of the bleaching agent renders the starch more soluble and therefore easier to be synergistically removed by the maltogenic alpha-amylase and the bleaching agent. It results as well in less redeposition on the surface to be cleaned.

Maltogenic alpha-amylases are known for various industrial applications. In particular, this enzyme finds potential application for retarding or preventing retrogradation and thus the staling of starch based common food as common in the baking industry. These enzymes are useful as well in the process for the manufacture of linear oligosaccharides or in the production of sweeteners and ethanol from starch and/or textile industry. A maltogenic alpha-amylase from Bacillus (EP 120 693) is commercially available under the tradename Novamyl® (Product of Novo Nordisk A/S, Denmark) and is widely used in the baking industry as an anti-staling agent due to its ability to reduce retrogradation of starch. WO99/43794 describes variants of maltogenic alpha-amylases with improved properties : altered pH optimum, improved thermostability, increased specific activity, altered cleavage pattern or increased ability to educe retrogradation of starch or staling of bread. WO99/43793 discloses variants of maltogenic alpha-amylases having CGT-ase activity, CGT-ase having maltogenic alpha-amylase activity and hybrid enzymes with one or more improvements to the specific properties of the parents enzymes.

However, the use of a maltogenic alpha-amylase with a detergent ingredient specifically selected from a nonionic surfactant, a protease enzyme and/or a bleaching agent; for the synergistic removal of starch-containing stains-soils in a detergent composition, has never been previously recognised.

### SUMMARY OF THE INVENTION

The present invention relates to detergent compositions, including laundry, dishwashing, and/or hard surface cleaner compositions, comprising a maltogenic alpha-amylase and a detergent ingredient selected from a nonionic surfactant, a protease enzyme and/or a bleaching agent. Such compositions provide excellent removal of starch-containing stains and soils, and when formulated as laundry compositions, excellent whiteness maintenance and dingy cleaning.

### DETAILED DESCRIPTION OF THE INVENTION

Maltogenic Alpha-amylase

The first essential component of the detergent compositions of the present invention is a maltogenic alpha amylase of the IUPAC Classification EC 3.2.1.133 that hydrolyses 1,4-α-D-glucosidic linkages in polysaccharides so as to remove successive alpha-maltose units from the nonreducing ends of the chains. Maltogenic alpha-amylases are thus able to hydrolyse amylose and amylopectin to maltose in the alpha-configuration and is also able to hydrolyse maltotriose as well as cyclodextrin. Such enzymes are also referred to as maltohydrolase (glucan 1,4-α-maltohydrolase).

Such maltogenic alpha-amylase is generally comprised in the detergent compositions of the present invention at a level of from 0.0002% to 10%, preferably 0.001% to 2%, more preferably 0.001% to 1% pure enzyme by weight of the total detergent composition.

Suitable maltogenic alpha-amylases for the purpose of the present invention are described below:

1) A suitable maltogenic alpha-amylase is the amylase cloned from Bacillus as described in EP 120 693 (hereinafter referred to as Novamyl). Novamyl has the amino acid sequence set forth in amino acids 1-686 of SEQ ID NO: 1 of WO99/47393. Novamyl is encoded in the gene harbored in the Bacillus strain NCIB 11837 which has the nucleic acid sequence set forth in SEQ ID NO:1 of WO99/47393.

2) WO99/43793 describes variants of maltogenic alpha-amylase having CGT-ase activity and variants of CGT-ase having maltogenic alpha-amylase activity, as well as constructed hybrid enzymes;that demonstrate the maltogenic alpha-amylase properties required for the enzymes of the present invention. In particular, WO99/43793 describes a polypeptide which:

a) has at least 70% identity to amino acids 1-686 of SEQ ID NO: 1 of WO99/43793;

b) comprises an amino acid modification which is an insertion, substitution or deletion compared to SEQ ID NO: 1 of WO99/43793 in a region corresponding to amino acids 40-43, 78-85, 136-139,173-180,188-195 or 259-268; and

c) has the ability to form cyclodextrin when acting on starch.

WO99/47393 further discloses a polypeptide which:

a) has an amino acid sequence having at least 70% identity to a parent cyclodextrin glucanotransferase (CGT-ase);

b) comprises an amino acid modification which is an insertion, substitution or deletion compared to the parent CGT-ase in a region corresponding to amino acids 40-43, 78-85, 136-139, 173-180, 188-195 or 259-268 of SEQ ID NO: 1 of WO99/43793; and

c) has the ability to form linear oligosaccharides when acting on starch.

In more details, WO99/43793 provides for variants of maltogenic alpha-amylase and CGT-ase and hybrids wherein the parent maltogenic alpha-amylase used in the invention is an enzyme classified in EC 3.2.1.133, preferably maltogenic alpha-amylase used, is the amylase cloned from Bacillus as described in EP 120 693 and wherein the parent CGT-ase used is an enzyme classified in EC 2.4.1.19. and has preferably one or more of the following characteristics:

i) an amino acid sequence having at least 50% identity to amino acids 1-686 of SEQ ID NO: 1 of WO99/43793, preferably at least 60%;

ii) being encoded by a DNA sequence which hybridizes at conditions described below to the DNA sequence set forth in SEQ ID NO:1 of WO99/43793or to the DNA sequence encoding Novamyl harbored in the Bacillus strain NCIB 11837; and

iii) a catalytic binding site comprising amino acid residues corresponding to D228, E256 and D329 as shown in the amino acid sequence set forth in amino acids 1-686 of SEQ ID NO: 1 of WO99/43793.

WO99/43793 describes variants of CGT-ase that has the ability to form linear oligosaccharides when acting on starch and hence have the desired maltogenic alpha-amylase properties required within the present invention. Such CGT-ase variant has a modification of at least one amino acid residue in a region corresponding to residues 40-43, 78-85, 136-139, 173-180, 189-195 or 259-268 of SEQ ID NO: 1 of WO99/43793. Each modification may be an insertion, a deletion or a substitution, of one or more amino acid residues in the region indicated. The modification of the parent CGT-ase is preferably such that the resulting modified amino acid or amino acid sequence more closely resembles the corresponding amino acid or structural region in Novamyl. Thus, the modification may be an insertion of or a substitution with an amino acid present at the corresponding position of Novamyl, or a deletion of an amino acid not present at the corresponding position of Novamyl.

The CGT-ase variant may particularly comprise an insertion into a position corresponding to the region D190-F194 of Novamyl (amino acid sequence shown in SEQ ID NO: 1 of WO99/43793). The insertion may comprise 3-7 amino acids, particularly 4-6, e.g. 5 amino acids. The insertion may be DPAGF as found in Novamyl or an analogue thereof, e.g. with the first amino acid being negative, the last one being aromatic, and the ones in between being preferably P, A or G. The variant may further comprise a substitution at the position corresponding to T189 of Novamyl with a neutral amino acid which is less bulky than F, Y or W. Other examples of insertions are DAGF, DPGF, DPF, DPAAGF, and DPAAGGF.

Modifications in the region 78-85 preferably include deletion of 2-5 amino acids, e.g. 3 or 4. Preferably, any aromatic amino acid in the region 83-85 should be deleted or substituted with a non-aromatic.

Modifications in the region 259-268 preferably include deletion of 1-3 amino acid, e.g. two. The region may be modified so as to correspond to Novamyl The CGT-ase variant may comprise further modifications in other regions, e.g. regions corresponding to amino acids 37-39, 44-45, 135, 140-145, 181-186, 269-273, or 377-383 of Novamyl.

Additional modifications of the amino acid sequence may be modeled on a second CGT-ase, i.e. an insertion of or substitution with an amino acid found at a given position in the second CGT-ase, or they may be made close to the substrate (less than 8 Å from the substrate, e.g. less than 5 Å or less than 3 Å) as described in WO 96/33267.

The following are some examples of variants based on a parent CGT-ase from Thermoanaerobacter (using B. circulans numbering). Similar variants may be made from other CGT-ases.

L194F+ *194aT+ *194bD+ *194cP+ *194dA+ *194eG+ D196S

L87H+ D89*+ T91G+ F91aY+ G92*+ G93*+ S94*+ L194F+ *194aT+ *194bD+ *194cP+ *194dA+ *194eG+ D196S

*194aT+ *194bD+ *194cP+ *194dA+ *194eG+ D196S

L87H+ D89*+ T91G+ F91aY+ G92*+ G93*+ S94*+ *194aT+ *194bD+ *194cP+ *194dA+ *194eG+ D196S

Y260F+ L261G+ G262D+ T263D+ N264P+ E265G+ V266T+ *266aA+ *266bN+ D267H+ P268V

*194aT+ *194bD+ *194cP+ *194dA+ *194eG+ D196S+ Y260F+ L261 G+ G262D+ T263D+ N264P+ E265G+ V266T+ *266aA+ *266bN+ D267H+P268V

WO99/43793 further describes Novamyl variants having the desired maltogenic alpha-amylase properties required within the present invention. Such Novamyl variant has as well the ability to form cyclodextrin when acting on starch and has a modification of at least one amino acid residue in the same regions described above for CGT-ase variants. However, the modifications are preferably in the opposite direction, i.e. such that the resulting modified amino acid or amino acid sequence more closely resembles the corresponding amino acid or structural region of a CGT-ase. Thus, the modification may be an insertion of or a substitution with an amino acid present at the corresponding position of a CGT-ase, or a deletion of an amino acid not present at the corresponding position of a CGT-ase. Preferred modifications include a deletion in the region 190-195, preferably the deletion Δ (191-195) and/or a substitution of amino acid 188 and/or 189, preferably F188L and/or Y189Y.

3) Other suitable maltogenic alpha-amylases suitable for the purpose of the present invention are described in WO99/43794. WO99/43794 describes modified amino acid sequences of a maltogenic alpha-amylase corresponding to variants with improved properties, based on the three-dimensional structure of the maltogenic alpha-amylase Novamyl. The variants have altered physicochemical properties., e.g. an altered pH optimum, improved thermostability, increased specific activity, an altered cleavage pattern or an increased ability to reduce retrogradation of starch or staling of bread.

In particular, WO99/47394 describes preferred maltogenic alpha-amylases that should have one or more of the following properties:

i) a three dimensional structural homology to Novamyl,

ii) an amino acid sequence having at least 70% identity to SEQ ID NO: 1 of WO99/47394, preferably at least 80% or 90%, e.g. 95% or 98%,

iii) a DNA sequence which hybridizes to the DNA sequence set forth in SEQ ID NO:1 of WO99/47394 or to the DNA sequence encoding Novamyl harbored in the Bacillus strain NCIB 11837;

iv) a calcium binding site comprising a coordination equivalent to a backbone carbonyl atom from Asn77, sidechain atom OE2 and OE1 from Glu102, a sidechain atom OD1 from Asp79, a sidechain atom OD1 from Asp76, and a sidechain atom OE1 from Glu101, and one water molecule WAT V21, atom OWO, wherein the positions are as shown in Appendix 1 of WO99/47394;

v) a sequence of five amino acids corresponding to Pro-Ala-Gly-Phe-Ser in a position equivalent to residues 191-195 in the amino acid sequence shown in SEQ ID NO: 1 of WO99/47394; and

The structural homology referred to above in i) is based on other sequence homologies, hydrophobic cluster analysis or by reverse threading (Huber, T; Torda, AE, PROTEIN SCIENCE Vol. 7 , No. 1 pp. 142-149 (1998)) and which by any of these methods is predicted to have the same tertiary structure as Novamyl, wherein the tertiary structure refers to the overall folding or the folding of Domains A, B, and C, more preferably including Domain D, and most preferably including Domain E. Alternatively, a structural alignment between Novamyl and a maltogenic alpha-amylase may be used to identify equivalent positions. The calcium binding site referred to above in iv) is based on a calcium binding site identified in the three-dimensional structure of Novamyl, and is discussed in details in the section “Calcium binding sites” of WO99/47394. The “equivalent position” referred to above in v) is based on amino acid or DNA sequence alignment or structural homology using methods known in the art.

Preferred maltogenic alpha-amylases for the purpose of the present invention are the Novamyl enzyme described in EP 120 693 ; the Novamyl variant based on the amino acid sequence shown in amino acids 1-686 of SEQ ID NO: 1 within which the residues 191-195 were removed, Phe188 was substituted with Leu and Thr189 was substituted with Tyr, termed Δ (191-195)-F188L-T189Y (See example 4 of WO99/43793); as well as the following 2 variants of Novamyl (See example 5 of WO99/43794): the variant wherein positions 191-195 have been deleted and the variant wherein positions 191-195 have been deleted and the following amino acids at the following positions have been substituted F188L/T189Y/T142A/N327S. More preferred enzyme is Novamyl.

Commercially available maltogenic alpha-amylase is the enzyme product sold under the tradename Novamyl, by Novo Nordisk A/S.

Preferred maltogenic alpha-amylases for specific applications are alkaline maltogenic alpha-amylase, i.e. enzymes having an enzymatic activity of at least 10%, preferably at least 25%, more preferably at least 40% of their maximum activity at a pH ranging from 7 to 12, preferably 10.5. More preferred maltogenic alpha-amylases are enzymes having their maximum activity at a pH ranging from 7 to 12, preferably 10.5.

In another embodiment of the present invention, the detergent compositions of the present invention might further comprise one or more starch-binding domain. Such starch binding domain might be added in the detergent compositions of the present invention, as such, or might be part of a chimeric maltogenic alpha-amylase hybrid. Indeed, the maltogenic alpha-amylase of the present inventions preferably will have or will be added a Starch Binding Domain (SBD). In general enzymes such as amylases, cellulases and xylanases have a modular structure consisting of a catalyst domain and at least one non-catalytic domain whose function is generally described as that of a polysaccharide-binding domain (PBD), starch-binding domain (SBD), cellulose-binding domain (CBD) and xylan-binding domain. The function of these binding domains is to bind selectively to the substrate of the enzyme, and in particular, the primary function of SBD is to bind to starch. It has been found surprisingly found that the detergent compositions of the present invention comprising further one or more SBD and/or wherein the maltogenic alpha-amylases comprise such a SBD will provide a more effective starch-containing soils/stains removal. It has further been found that such enzymes can be formulated in a more cost-effective manner. Without wishing to be bound by theory, it is believed that such maltogenic alpha-amylase will be more effectively directed specifically to their substrate from the wash solutions and so have improved deposition onto the starch containing stains/soils for improved and/or new performance. Moreover, it is believed that the binding of the SBD will disrupt the surface of starch resulting in a higher hydrolytic rate. Suitable SBD for use in the present invention are the SBDs comprised in the glucoamylase from Aspergillus niger (Sigma) and in the β-galactosidase from A. awamori. The recovery and fusion of SBDs can be achieved as described in Ford, C. et al., J. Cell. Biochem. (Suppl.) 14D:30 (1990) and in Chen, L. et al., Abst. Annu. Meet. Am. Soc. MicrobioL. 90:269 (1990).

The above-mentioned enzymes may be of any suitable origin, such as vegetable, animal, bacterial, fungal and yeast origin. Origin can further be mesophilic or extremophilic (psychrophilic, psychrotrophic, thermophilic, barophilic, alkalophilic, acidophilic, halophilic, etc.). Purified or non-purified forms of these enzymes may be used. Nowadays, it is common practice to modify wild-type enzymes via protein/genetic engineering techniques in order to optimise their performance efficiency in the detergent compositions of the invention. For example, the variants may be designed such that the compatibility of the enzyme to commonly encountered ingredients of such compositions is increased. Alternatively, the variant may be designed such that the optimal pH, bleach or chelant stability, catalytic activity and the like, of the enzyme variant is tailored to suit the particular cleaning application.

In particular, attention should be focused on amino acids sensitive to oxidation in the case of bleach stability and on surface charges for the surfactant compatibility. The isoelectric point of such enzymes may be modified by the substitution of some charged amino acids, e.g. an increase in isoelectric point may help to improve compatibility with anionic surfactants. The stability of the enzymes may be further enhanced by the creation of e.g. additional salt bridges and enforcing metal binding sites to increase chelant stability.

Nonionic Surfactants

The detergent compositions of the present invention can comprise as the second essential element, a nonionic surfactant. As described below, preferred nonionic surfactants are selected from polyethylene oxide condensates of alkyl alcohols, amide oxide and polyethylene oxide condensates of alkyl acids and/or mixtures thereof.

The nonionic surfactants are generally comprised at a level of 0.05-30% by weight, preferably from 0.1-10% by weight of the total composition.

As mentioned above, it has been surprisingly found that the detergent compositions of the present invention comprising a nonionic surfactant, provide synergistic removal of starch from fabrics, dishware and other hard surfaces. Without wishing to be bound by theory, it is believed that the nonionic surfactant adsorbs onto the granular surface of the starch thereby disrupting the starch structure and influencing and preventing the retrogradation process of the starch. Such disruption of the structure increases the maltogenic alpha-amylase accessibility to its substrate. Moreover, nonionic surfactants can be used also in a pre-treatment process and therefore can reduce the retrogradation process of starch. Hence, the starch-containing stains/soils is more easily hydrolysed by the enzyme and a synergistic breakdown of the starch soil by the maltogenic alpha-amylase and the nonionic surfactant occurs.

The nonionic surfactant which can be used in the present invention may comprise essentially any alkoxylated nonionic surfactant. The ethoxylated and propoxylated nonionic surfactants are preferred. Preferred alkoxylated surfactants can be selected from the classes of the nonionic condensates of alkyl phenols, nonionic ethoxylated alcohols, nonionic ethoxylated/propoxylated fatty alcohols, nonionic ethoxylate/propoxylate condensates with propylene glycol, and the nonionic ethoxylate condensation products with propylene oxide/ethylene diamine adducts. Highly preferred are nonionic alkoxylated alcohol surfactants, being the condensation products of aliphatic alcohols with from 1 to 125 moles of alkylene oxide, in particular about 50 or from 1 to 15 moles, preferably to 11 moles, particularly ethylene oxide and/or propylene oxide, are highly preferred nonionic surfactant comprised in the anhydrous component of the particles of the invention. The alkyl chain of the aliphatic alcohol can either be straight or branched, primary or secondary, and generally contains from 6 to 22 carbon atoms. Particularly preferred are the condensation products of alcohols having an alkyl group containing from 8 to 20 carbon atoms with from 2 to 9 moles and in particular 3.5 or 7 moles, of ethylene oxide per mole of alcohol.

The nonionic surfactant which can be used in the present invention may also comprise polyhydroxy fatty acid amides, in particular those having the structural formula R²CONR¹Z wherein : R1 is H, C₁₋₁₈, preferably C₁-C₄ hydrocarbyl, 2-hydroxy ethyl, 2-hydroxy propyl, ethoxy, propoxy, or a mixture thereof, preferable C1-C4 alkyl, more preferably C₁ or C₂ alkyl, most preferably C₁ alkyl (i.e., methyl); and R₂ is a C₅-C₃₁ hydrocarbyl, preferably straight-chain C₅-C₁₉ or C₇-C₁₉ alkyl or alkenyl, more preferably straight-chain C₉-C₁₇ alkyl or alkenyl, most preferably straight-chain C₁₁-C₁₇ alkyl or alkenyl, or mixture thereof; and Z is a polyhydroxyhydrocarbyl having a linear hydrocarbyl chain with at least 3 hydroxyls directly connected to the chain, or an alkoxylated derivative (preferably ethoxylated or propoxylated) thereof. Z preferably will be derived from a reducing sugar in a reductive amination reaction; more preferably Z is a glycityl. A preferred nonionic polyhydroxy fatty acid amide surfactant for use herein is a C₁₂-C₁₄, a C₁₅-C₁₇ and/or C₁₆-C₁₈ alkyl N-methyl glucamide. It may be particularly preferred that the composition herein comprises a mixture of a C₁₂-C₁₈ alkyl N-methyl glucamide and condensation products of an alcohol having an alkyl group containing from 8 to 20 carbon atoms with from 2 to 9 moles and in particular 3, 5 or 7 moles, of ethylene oxide per mole of alcohol. The polyhydroxy fatty acid amide can be prepared by any suitable process. One particularly preferred process is described in detail in WO 9206984. A product comprising about 95% by weight polyhydroxy fatty acid amide, low levels of undesired impurities such as fatty acid esters and cyclic amides, and which is molten typically above about 80° C., can be made by this process.

The nonionic surfactant for use in the present invention may also comprise a fatty acid amide surfactant or alkoxylated fatty acid amide. They include those nonionic surfactants having the formula: R⁶CON(R⁷)(R⁸ ) wherein R⁶ is an alkyl group containing from 7 to 21, preferably from 9 to 17 carbon or even 11 to 13 carbon atoms and R⁷ and R⁸ are each individually selected from the group consisting of hydrogen, C₁-C₄ alkyl, C₁-C₄ hydroxyalkyl, and —(C₂H₄O)ₓH, where x is in the range of from 1 to 11, preferably 1 to 7, whereby it may be preferred that R⁷ is different to R⁸, one having x being 1 or 2, one having x being from 3 to 11 or preferably from 3 to 7.

The nonionic surfactant for use in the present invention may also comprise an alkyl ester of a fatty acid. These nonionic surfactants include those having the formula: R⁹COO(R¹⁰) wherein R⁹ is an alkyl group containing from 7 to 21, preferably from 9 to 17 carbon or even 11 to 13 carbon atoms and R¹⁰ is a C₁-C₄ alkyl, C₁-C₄ hydroxyalkyl, or —(C₂H₄O)ₓH, where x is in the range of from 1 to 11, preferably from 1 to 7, more preferably from 1 to 5, whereby it may be preferred that R¹⁰ is a methyl or ethyl group.

The nonionic surfactant for use in the present invention may also comprise an alkylpolysaccharide, such as those disclosed in U.S. Pat. No. 4,565,647, Llenado, issued Jan. 21, 1986, having a hydrophobic group containing from 6 to 30 carbon atoms and a polysaccharide, e.g., a polyglycoside, hydrophilic group containing from 1.3 to 10 saccharide units.

Preferred alkylpolyglycosides have the formula

R²O(CₙH₂ₙO)t(glycosyl)ₓ

wherein R² is selected from the group consisting of alkyl, alkylphenyl, hydroxyalkyl, hydroxyalkylphenyl, and mixtures thereof in which the alkyl groups contain from 10 to 18 carbon atoms; n is 2 or 3; t is from 0 to 10, and x is from 1.3 to 8. The glycosyl is preferably derived from glucose.

Also suitable as nonionic surfactants for the purpose of the present invention are the semi-polar nonionic surfactants: Semi-polar nonionic surfactants are a special category of nonionic surfactants which include water-soluble amine oxides containing one alkyl moiety of from about 10 to about 18 carbon atoms and 2 moieties selected from the group consisting of alkyl groups and hydroxyalkyl groups containing from about 1 to about 3 carbon atoms; water-soluble phosphine oxides containing one alkyl moiety of from about 10 to about 18 carbon atoms and 2 moieties selected from the group consisting of alkyl groups and hydroxyalkyl groups containing from about 1 to about 3 carbon atoms; and water-soluble sulfoxides containing one alkyl moiety of from about 10 to about 18 carbon atoms and a moiety selected from the group consisting of alkyl and hydroxyalkyl moieties of from about 1 to about 3 carbon atoms. Semi-polar nonionic detergent surfactants include the amine oxide surfactants having the formula

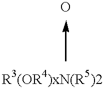

wherein R³ is an alkyl, hydroxyalkyl, or alkyl phenyl group or mixtures therof containing from about 8 to about 22 carbon atoms; R⁴ is an alkylene or hydroxyalkylene group containing from about 2 to about 3 carbon atoms or mixtures thereof; x is from 0 to about 3; and each R⁵ is an alkyl or hydroxyalkyl group containing from about 1 to about 3 carbon atoms or a polyethylene oxide group containing from about 1 to about 3 ethylene oxide groups. The R⁵ groups can be attached to each other, e.g., through an oxygen or nitrogen atom, to form a ring structure.

These amine oxide surfactants in particular include C₁₀-C₁₈ alkyl dimethyl amine oxides and C₈-C₁₂ alkoxy ethyl dihydroxy ethyl amine oxides.

When included therein, the cleaning compositions of the present invention typically comprise from 0.2% to about 15%, preferably from about 1% to about 10% by weight of such semi-polar nonionic surfactants.

Also suitable as nonionic surfactants for the purpose of the present invention are the co-surfactant selected from the group of primary or tertiary amines. Suitable primary amines for use herein include amines according to the formula R₁NH₂ wherein R₁ is a C₆-C₁₂, preferably C₆-C₁₀ alkyl chain or R₄X(CH2)ₙ, X is —O—, —C(O)NH— or —NH—, R₄ is a C₆-C₁₂ alkyl chain n is between 1 to 5, preferably 3. R₁ alkyl chains may be straight or branched and may be interrupted with up to 12, preferably less than 5 ethylene oxide moieties.

Preferred amines according to the formula herein above are n-alkyl amines. Suitable amines for use herein may be selected from 1 -hexylamine, 1 -octylamine, 1-decylamine and laurylamine. Other preferred primary amines include C8-C10oxypropylamine, octyloxypropylamine, 2-ethylhexyl-oxypropylamine, lauryl amido propylamine and amido propylamine.

Suitable tertiary amines for use herein include tertiary amines having the formula R₁R₂R₃N wherein R1 and R2 are C₁-C₈ alkylchains or

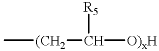

R₃ is either a C₆-C₁₂, preferably C₆-C₁₀ alkyl chain, or R₃ is R₄X(CH₂)ₙ, whereby X is —O—, —C(O)NH— or —NH—, R₄ is a C₄-C₁₂, n is between 1 to 5, preferably 2-3. R₅ is H or C₁-C₂ alkyl and x is between 1 to 6 .

R₃ and R₄ may be linear or branched; R₃ alkyl chains may be interrupted with up to 12, preferably less than 5, ethylene oxide moieties.

Preferred tertiary amines are R₁R₂R₃N where R1 is a C6-C12 alkyl chain, R2 and R3 are C1-C3 alkyl or

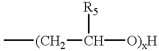

where R5 is H or CH3 and x=1-2.

Also preferred are the amidoamines of the formula:

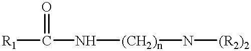

wherein R₁ is C₆-C₁₂ alkyl; n is 2-4, preferably n is 3; R₂ and R₃ is C₁-C₄

Most preferred amines of the present invention include 1-octylamine, 1-hexylamine, 1-decylamine, 1-dodecylamine,C8-10 oxypropylamine, N coco 1-3diaminopropane, coconutalkyldimethylamine, lauryldimethylamine, lauryl bis(hydroxyethyl)amine, coco bis(hydroxyehtyl)amine, lauryl amine 2 moles propoxylated, octyl amine 2 moles propoxylated, lauryl amidopropyidimethylamine, C8-10 amidopropyidimethylamine and C10 amidopropyldimethylamine.

The most preferred amines for use in the compositions herein are 1-hexylamine, 1-octylamine, 1-decylamine, 1-dodecylamine. Especially desirable are n-dodecyidimethylamine and bishydroxyethylcoconutalkylamine and oleylamine 7 times ethoxylated, lauryl amido propylamine and cocoamido propylamine.

Protease Enzymes

A second essential element of the detergent compositions of the present invention can be a protease enzyme. As mentioned above, the starch containing stains and soils comprise many proteins components as well. Without wishing to be bound by theory it is believed that the protease enzyme hydrolyses the proteins contains in such complex stains and thereby induces the synergistic removal of such stains/soils with the maltogenic alpha-amylase. In addition, such hydrolysed complex stains/soils have a lower molecular weight in the wash solution and therefore it results in less redeposition of such hydrolysed complex stains on the surface to be cleaned. Suitable proteases are the subtilisins which are obtained from particular strains of B. subtilis and B. licheniformis (subtilisin BPN and BPN′). One suitable protease is obtained from a strain of Bacillus, having maximum activity throughout the pH range of 8-12, developed and sold as ESPERASE® by Novo Industries A/S of Denmark, hereinafter “Novo”. The preparation of this enzyme and analogous enzymes is described in GB 1,243,784 to Novo. Other suitable proteases include ALCALASE®, DURAZYM® and SAVINASE® (protease Subtilisin 309 from Bacillius subtilis) from Novo and MAXATASE®, MAXACAL®, PROPERASE® and MAXAPEM® (protein engineered Maxacal) from Gist-Brocades. Also suitable for the present invention are proteases described in patent applications EP 251 446 and WO 91/06637, protease BLAP® described in WO91/02792 and their variants described in WO 95/23221. See also a high pH protease from Bacillus sp. NCIMB 40338 described in WO 93/18140 A to Novo. Enzymatic detergents comprising protease, one or more other enzymes, and a reversible protease inhibitor are described in WO 92/03529 A to Novo. When desired, a protease having decreased adsorption and increased hydrolysis is available as described in WO 95/07791 to Procter & Gamble. A recombinant trypsin-like protease for detergents suitable herein is described in WO 94/25583 to Novo. Other suitable proteases are described in EP 516 200 by Unilever.

Proteolytic enzymes also encompass modified bacterial serine proteases, such as those described in EP 251 446, filed Apr. 28, 1987 (particularly the variant Y217L described on pages 17, 24 and 98), and which is called herein “Protease B”, and in European Patent Application 199,404, Venegas, published Oct. 29, 1986, which refers to a modified bacterial serine protealytic enzyme which is called “Protease A” herein. Suitable is what is called herein “Protease C”, which is a variant of an alkaline serine protease from Bacillus in which lysine replaced arginine at position 27, tyrosine replaced valine at position 104, serine replaced asparagine at position 123, and alanine replaced threonine at position 274. Protease C is described in WO 91/06637. Genetically modified variants, particularly of Protease C, are also included herein.

A preferred protease referred to as “Protease D” is a carbonyl hydrolase variant having an amino acid sequence not found in nature, which is derived from a precursor carbonyl hydrolase by substituting a different amino acid for a plurality of amino acid residues at a position in said carbonyl hydrolase equivalent to position +76, preferably also in combination with one or more amino acid residue positions equivalent to those selected from the group consisting of +99, +101, +103, +104, +107, +123, +27, +105, +109, +126, +128, +135, +156, +166, +195, +197, +204, +206, +210, +216, +217, +218, +222, +260, +265, and/or +274 according to the numbering of Bacillus amyloliquefaciens subtilisin, as described in WO95/10591 and WO95/10592. The “protease D” variants have preferably the amino acid substitution set 76/103/104, more preferably the substitution set N76D/S103A/V104l. Also suitable is a carbonyl hydrolase variant of the protease described in WO95/10591, having an amino acid sequence derived by replacement of a plurality of amino acid residues replaced in the precursor enzyme corresponding to position +210 in combination with one or more of the following residues: +33, +62, +67, +76, +100, +101, +103, +104, +107, +128, +129, +130, +132, +135, +156, +158, +164, +166, +167, +170, +209, +215, +217, +218, and +222, where the numbered position corresponds to naturally-occurring subtilisin from Bacillus amyloliquefaciens or to equivalent amino acid residues in other carbonyl hydrolases or subtilisins, such as Bacillus lentus subtilisin (co-pending patent application published under WO98/55634). More preferred proteases are multiply-substituted protease variants. These protease variants comprise a substitution of an amino acid residue with another naturally occuring amino acid residue at an amino acid residue position corresponding to position 103 of Bacillus amyloliquefaciens subtilisin in combination with a substitution of an amino acid residue positions corresponding to positions 1, 3, 4, 8, 9, 10, 12, 13, 16, 17, 18, 19, 20, 21, 22, 24, 27, 33, 37, 38, 42, 43, 48, 55, 57, 58, 61, 62, 68, 72, 75, 76, 77, 78, 79, 86, 87, 89, 97, 98, 99, 101, 102, 104, 106, 107, 109, 111, 114, 116, 117, 119, 121, 123, 126, 128, 130, 131, 133, 134, 137, 140, 141, 142, 146, 147, 158, 159, 160, 166, 167, 170, 173, 174, 177, 181, 182, 183, 184, 185, 188, 192, 194, 198, 203, 204, 205, 206, 209, 210, 211, 212, 213, 214, 215, 216, 217, 218, 222, 224, 227, 228, 230, 232, 236, 237, 238, 240, 242, 243, 244, 245, 246, 247, 248, 249, 251, 252, 253, 254, 255, 256, 257, 258, 259, 260, 261, 262, 263, 265, 268, 269, 270, 271, 272, 274 and 275 of Bacillus amyloliquefaciens subtilisin; wherein when said protease variant includes a substitution of amino acid residues at positions corresponding to positions 103 and 76, there is also a substitution of an amino acid residue at one or more amino acid residue positions other than amino acid residue positions corresponding to positions 27, 99, 101, 104, 107, 109, 123, 128, 166, 204, 206, 210, 216, 217, 218, 222, 260, 265 or 274 of Bacillus amyloliquefaciens subtilisin and/or multiply-substituted protease variants comprising a substitution of an amino acid residue with another naturally occuring amino acid residue at one or more amino acid residue positions corresponding to positions 62, 212, 230, 232, 252 and 257 of Bacillus amyloliquefaciens subtilisin as described in WO99/20727, WO99/20726 and WO99/20723 all filed on Oct. 23, 1998 from The Procter & Gamble Company. Preferred multiply substituted protease variants have the amino acid substitution set 101/103/104/159/232/236/245/248/252, more preferably 101G/103A/104l/159D/232V/236H/245R/248D/252K according to the numbering of Bacillus amyloliquiefaciens subtilisin.

More preferred proteases for the purpose of the present invention are the proteolytic enzymes sold under the tradename Savinase by Novo Nordisk A/S, the “Protease B” variant with the substitution Y217L described in EP 251 446, the “protease D” variant with the substitution set N76D/S103A/V104l and the protease described in WO99/20727, WO99/20726 and WO99/20723 with the amino acid substitution set 101G/103A/104l/159D/232V/236H/245R/248D/252K.

The protease enzymes are normally incorporated in the detergent composition at levels from 0.0001% to 2%, preferably 0.0001% to 0.1%, more preferably 0.001% to 0.05%, of pure enzyme by weight of the detergent composition.

Bleaching Agent

A second essential element of the detergent compositions of the present invention can be a bleaching agent. Without wishing to be bound by theory, it is believed that the oxidisation of the starch material by a bleaching agent solubilises the starch materials, which are therefore more easily removed and results in less redeposition on the surface to be cleaned. Hence, the compositions of the present invention further comprising a bleaching agent will provide synergistic removal of starch-containing stains and soils, and when formulated as laundry compositions, improved whiteness maintenance and dingy cleaning.

Preferred bleaching agents for the detergent compositions of the present invention are the combination of percarbonate with a bleach activator selected from nonanoyloxybenzene-sulfonate (NOBS), Phenolsulfonate ester of N-nonanoyl-6-aminocaproic acid (NACA-OBS), and/or tetraacetylethylenediamine (TAED). Also preferred are the bleaching agents referred to as [Mn(Bcyclam)Cl₂].

Suitable bleaching agents for the purpose of the present invention include hydrogen peroxide, PB1, PB4 and percarbonate with a particle size of 400-800 microns. These bleaching agent components can include one or more oxygen bleaching agents and, depending upon the bleaching agent chosen, one or more bleach activators. When present oxygen bleaching compounds will typically be present at levels of from 0.1% to 30%, preferably 1% to 20% by weight of the detergent composition.

The bleaching agent component for use herein can be any of the bleaching agents useful for detergent compositions including oxygen bleaches as well as others known in the art. The bleaching agent suitable for the present invention can be an activated or non-activated bleaching agent.

One category of oxygen bleaching agent that can be used encompasses percarboxylic acid bleaching agents and salts thereof. Suitable examples of this class of agents include magnesium monoperoxyphthalate hexahydrate, the magnesium salt of meta-chloro perbenzoic acid, 4-nonylamino-4-oxoperoxybutyric acid and diperoxydodecanedioic acid. Such bleaching agents are disclosed in U.S. Pat. No. 4,483,781, U.S. patent application No.740,446, European Patent Application 0,133,354 and U.S. Pat. No. 4,412,934. Highly preferred bleaching agents also include 6-nonylamino-6-oxoperoxycaproic acid as described in U.S. Pat. No. 4,634,551.

Another category of bleaching agents that can be used encompasses the halogen bleaching agents. Examples of hypohalite bleaching agents, for example, include trichloro isocyanuric acid and the sodium and potassium dichloroisocyanurates and N-chloro and N-bromo alkane sulphonamides. Such materials are normally added at 0.5-10% by weight of the finished product, preferably 1-5% by weight.

The hydrogen peroxide releasing agents can be used in combination with bleach activators such as tetraacetylethylenediamine (TAED), nonanoyloxybenzene-sulfonate (NOBS, described in U.S. Pat. No. 4,412,934), 3,5,-trimethylhexanoloxybenzenesulfonate (ISONOBS, described in EP 120,591) or pentaacetylglucose (PAG) or Phenolsulfonate ester of N-nonanoyl-6-aminocaproic acid (NACA-OBS, described in WO94/28106), which are perhydrolyzed to form a peracid as the active bleaching species, leading to improved bleaching effect. Also suitable activators are acylated citrate esters such as disclosed in EP 624 154 and the unsymetrical acyclic imide bleach activator of the following formula as disclosed in the Procter & Gamble WO98/04664:

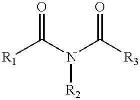

wherein R₁ is a C₇-C₁₃ linear or branched chain saturated or unsaturated alkyl group, R₂ is a C₁-C₈ linear or branched chain saturated or unsaturated alkyl group and R₃ is a C₁-C₄ linear or branched chain saturated or unsaturated alkyl group. Those bleach activators are generally used within the detergent compositions of the present invention at a level of 0.1-10%, preferably 0.5-5% by weight of the detergent composition.

Useful bleaching agents, including peroxyacids and bleaching systems comprising bleach activators and peroxygen bleaching compounds for use in detergent compositions according to the invention are described in our co-pending applications WO95/10592, WO97/00937, WO95/27772, WO95/27773, WO95/27774 and WO95/27775.

The hydrogen peroxide may also be present by adding an enzymatic system (i.e. an enzyme and a substrate therefore) which is capable of generating hydrogen peroxide at the beginning or during the washing and/or rinsing process. Such enzymatic systems are disclosed in EP 537 381.

Metal-containing catalysts for use in bleach compositions, include cobalt-containing catalysts such as Pentaamine acetate cobalt(III) salts and manganese-containing catalysts such as those described in EPA 549 271; EPA 549 272; EPA 458 397; U.S. Pat. No. 5,246,621; EPA 458 398; U.S. Pat. No. 5,194,416 and U.S. Pat. No. 5,114,611. Bleaching composition comprising a peroxy compound, a manganese-containing bleach catalyst and a chelating agent is described in the patent application No. 94870206.3. The bleaching compounds can be catalyzed by means of a manganese compound. Such compounds are well known in the art and include, for example, the manganese-based catalysts disclosed in U.S. Pat. No. 5,246,621, U.S. Pat. No. 5,244,594; U.S. Pat. No. 5,194,416; U.S. Pat. Mo. 5,114,606; and European Pat. App. Pub. Nos. 549,271A1, 549,272A1, 544,440A2, and 544,490A1; Preferred examples of these catalysts include Mn^{IV}₂(u-O)₃(1,4,7-trimethyl-1,4,7-triazacyclononane)₂(PF₆)₂, Mn^{III}₂(u-O)₁(u-OAc)₂(1,4,7-trimethyl-1,4,7-triazacyclononane)₂(ClO₄)₂, Mn^{IV}₄(u-O)₆(1,4,7-triazacyclononane)₄(ClO₄)_{4,} Mn^{III}Mn^{IV}₄(u-O)₁(u-OAc)₂₋(1,4,7-trimethyl-1,4,7-triazacyclononane)₂(ClO₄)₃, Mn^{IV}(1,4,7-trimethyl-1,4,7-triazacyclononane)-(OCH₃)₃(PF₆), and mixtures thereof.

More preferred for use therein are the transition metal bleach catalysts being complexes of a transition metal and a cross bridged macropolycyclic ligands such as described in Procter & Gamble patent applications WO 98/39405, WO 98/39406 and WO 98/39098. Most preferred is the Mn Complex Bleach Catalyst of the formula [Mn(Bcyclam)CI₂] illustrated as:

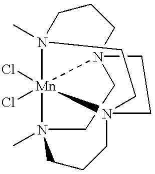

“Bcyclam” (5,12-dimethyl-1,5,8,12-tetraaza-bicyclo[6.6.2]hexadecane or 5,12-diethyl-1,5,8,1 2-tetraaza-bicyclo[6.6.2]hexadecane). Such transition-metal bleach catalyst can be prepared according to Procter & Gamble patent application WO98/39335 or according to J.Amer.Chem.Soc., (1990), 112, 8604. These bleach catalysts are generally encompassed in the detergent compositions of the present invention at a level of 0.0007-0.07%, preferably 0.005-0.05% by weight of the detergent compositions.

Bleaching agents other than oxygen bleaching agents are also known in the art and can be utilized herein. One type of non-oxygen bleaching agent of particular interest includes photoactivated bleaching agents such as the sulfonated zinc and/or aluminum phthalocyanines. These materials can be deposited upon the substrate during the washing process. Upon irradiation with light, in the presence of oxygen, such as by hanging clothes out to dry in the daylight, the sulfonated zinc phthalocyanine is activated and, consequently, the substrate is bleached. Preferred zinc phthalocyanine and a photoactivated bleaching process are described in U.S. Pat. No. 4,033,718. Typically, detergent compositions will contain about 0.025% to about 1.25%, by weight, of sulfonated zinc phthalocyanine.

Also suitable as bleaching species for the purpose of the present invention are a colour-safe bleach boosters that may be used in conjunction with a peroxygen source in a bleaching composition. The bleach booster is generally present in the detergent compositions at a level of from 0.01-10% and more preferably from 0.05-5% by weight of the composition. Bleach boosters to be included in the detergent compositions of the present invention comprise zwitterionic imines, anionic imine polyions having a net negative charge of from about −1 to about −3, and mixtures thereof.

Suitable imine bleach boosters of the present invention include those of the general structure:

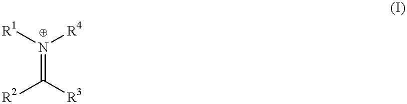

where R¹-R⁴ may be a hydrogen or an unsubstituted or substituted radical selected from the group consisting of phenyl, aryl, heterocyclic ring, alkyl and cycloalkyl radicals except that at least one of R¹-R⁴ contains an anionically charged moiety.

Preferred bleach boosters are the anionically charged moiety bonded to the imine nitrogen described in WO97/10323. Also preferred are the tri:cyclic oxaziridinium compounds described in U.S. Pat. No. 5,710,116 and the bleach boosters described in WO98/16614. These can be prepared in accordance with the method described in WO97/10323 and/or WO98/16614.

Detergent Components

The detergent compositions of the present invention will preferably comprise a further enzyme selected from a lipase, an α-amylase, a cyclomaltodextrin glucanotransferase and/or an amyloglucosidase.

In a preferred embodiment, the present invention relates to a laundry and/or fabric care composition comprising a maltogenic alpha-amylase and a detergent ingredient selected from a nonionic surfactant, a protease enzyme and/or a bleaching agent (Examples 1-17). In a second embodiment, the present invention relates to dishwashing or household cleaning compositions (Examples 18-23).

The compositions of the invention may for example, be formulated as hand and machine dishwashing compositions, hand and machine laundry detergent compositions including laundry additive compositions and compositions suitable for use in the soaking and/or pre-treatment of stained fabrics, rinse added fabric softener compositions, and compositions for use in general household hard surface cleaning operations. When formulated as compositions for use in manual dishwashing methods the compositions of the invention preferably contain a surfactant and preferably other detergent compounds selected from organic polymeric compounds, suds enhancing agents, group II metal ions, solvents, hydrotropes and additional enzymes.

When formulated as compositions suitable for use in a laundry machine washing method, the compositions of the invention preferably contain both a surfactant and a builder compound and additionally one or more detergent components preferably selected from organic polymeric compounds, bleaching agents, additional enzymes, suds suppressors, dispersants, lime-soap dispersants, soil suspension and anti-redeposition agents and corrosion inhibitors. Laundry compositions can also contain softening agents, as additional detergent components. Such compositions containing a detergent ingredient selected from a nonionic surfactant, a protease enzyme and/or a bleaching agent and a maltogenic alpha-amylase provide starch-containing stain removal, whiteness maintenance and dingy cleaning when formulated as laundry detergent compositions.

The compositions of the invention can also be used as detergent additive products. Such additive products are intended to supplement or boost the performance of conventional detergent compositions.

The detergent compositions according to the invention can be liquid, paste, gels, bars, tablets, spray, foam, powder or granular. Granular compositions can also be in “compact” form and the liquid compositions can also be in a “concentrated” form. If needed the density of the laundry detergent compositions herein ranges from 400 to 1200 g/liter, preferably 500 to 950 g/liter of composition measured at 20° C. The “compact” form of the compositions herein is best reflected by density and, in terms of composition, by the amount of inorganic filler salt; inorganic filler salts are conventional ingredients of detergent compositions in powder form; in conventional detergent compositions, the filler salts are present in substantial amounts, typically 17-35% by weight of the total composition. In the compact compositions, the filler salt is present in amounts not exceeding 15% of the total composition, preferably not exceeding 10%, most preferably not exceeding 5% by weight of the composition. The inorganic filler salts, such as meant in the present compositions are selected from the alkali and alkaline-earth-metal salts of sulphates and chlorides. A preferred filler salt is sodium sulphate. Liquid detergent compositions according to the present invention can also be in a “concentrated form”, in such case, the liquid detergent compositions according the present invention will contain a lower amount of water, compared to conventional liquid detergents. Typically the water content of the concentrated liquid detergent is preferably less than 40%, more preferably less than 30%, most preferably less than 20% by weight of the detergent composition.

Suitable detergent compounds for use herein are selected from the group consisting of the below described compounds.

Surfactant System

The detergent compositions according to the present invention can comprise in addition to the nonionic surfactant, a surfactant system wherein the surfactant can be selected from anionic and/or cationic and/or ampholytic and/or zwitterionic surfactants.

The surfactant is typically present at a level of from 0.1% to 60% by weight. More preferred levels of incorporation are 1% to 35% by weight, most preferably from 1% to 30% by weight of detergent compositions in accord with the invention.

The surfactant is preferably formulated to be compatible with enzyme components present in the composition. In liquid or gel compositions the surfactant is most preferably formulated such that it promotes, or at least does not degrade, the stability of any enzyme in these compositions.

Anionic Surfactants

Suitable anionic surfactants to be used are linear alkyl benzene sulfonate, alkyl ester sulfonate surfactants including linear esters of C₈-C₂₀ carboxylic acids (i.e., fatty acids) which are sulfonated with gaseous SO₃ according to “The Journal of the American Oil Chemists Society”, 52 (1975), pp. 323-329. Suitable starting materials would include natural fatty substances as derived from tallow, palm oil, etc.

The preferred alkyl ester sulfonate surfactant, especially for laundry applications, comprise alkyl ester sulfonate surfactants of the structural formula:

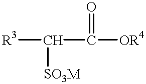

wherein R³ is a C₈-C₂₀ hydrocarbyl, preferably an alkyl, or combination thereof, R⁴ is a C₁-C₆ hydrocarbyl, preferably an alkyl, or combination thereof, and M is a cation which forms a water soluble salt with the alkyl ester sulfonate. Suitable salt-forming cations include metals such as sodium, potassium, and lithium, and substituted or unsubstituted ammonium cations, such as monoethanolamine, diethanolamine, and triethanolamine. Preferably, R³ is C₁₀-C₁₆ alkyl, and R⁴ is methyl, ethyl or isopropyl. Especially preferred are the methyl ester sulfonates wherein R³ is C₁₀-C₁₆ alkyl.

Other suitable anionic surfactants include the alkyl sulfate surfactants which are water soluble salts or acids of the formula ROSO₃M wherein R preferably is a C₁₀-C₂₄ hydrocarbyl, preferably an alkyl or hydroxyalkyl having a C₁₀-C₂₀ alkyl component, more preferably a C₁₂-C₁₈ alkyl or hydroxyalkyl, and M is H or a cation, e.g., an alkali metal cation (e.g. sodium, potassium, lithium), or ammonium or substituted ammonium (e.g. methyl-, dimethyl-, and trimethyl ammonium cations and quaternary ammonium cations such as tetramethyl-ammonium and dimethyl piperdinium cations and quaternary ammonium cations derived from alkylamines such as ethylamine, diethylamine, triethylamine, and mixtures thereof, and the like). Typically, alkyl chains of C₁₂-C₁₆ are preferred for lower wash temperatures (e.g. below about 50° C.) and C₁₆₋₁₈ alkyl chains are preferred for higher wash temperatures (e.g. above about 50° C.).

Other anionic surfactants useful for detersive purposes can also be included in the detergent compositions of the present invention. These can include salts (including, for example, sodium, potassium, ammonium, and substituted ammonium salts such as mono-, di- and triethanolamine salts) of soap, C₈-C₂₂ primary of secondary alkanesulfonates, C₈-C₂₄ olefinsulfonates, sulfonated polycarboxylic acids prepared by sulfonation of the pyrolyzed product of alkaline earth metal citrates, e.g., as described in British patent specification No. 1,082,179, C₈-C₂₄ alkylpolyglycolethersulfates (containing up to 10 moles of ethylene oxide); alkyl glycerol sulfonates, fatty acyl glycerol sulfonates, fatty oleyl glycerol sulfates, alkyl phenol ethylene oxide ether sulfates, paraffin sulfonates, alkyl phosphates, isethionates such as the acyl isethionates, N-acyl taurates, alkyl succinamates and sulfosuccinates, monoesters of sulfosuccinates (especially saturated and unsaturated C₁₂-C₁₈ monoesters) and diesters of sulfosuccinates (especially saturated and unsaturated C₆-C₁₂ diesters), acyl sarcosinates, sulfates of alkylpolysaccharides such as the sulfates of alkylpolyglucoside (the nonionic nonsulfated compounds being described below), branched primary alkyl sulfates, and alkyl polyethoxy carboxylates such as those of the formula RO(CH₂CH₂O)ₖ—CH₂COO—M+ wherein R is a C₈-C₂₂ alkyl, k is an integer from 1 to 10, and M is a soluble salt-forming cation. Resin acids and hydrogenated resin acids are also suitable, such as rosin, hydrogenated rosin, and resin acids and hydrogenated resin acids present in or derived from tall oil.

Further examples are described in “Surface Active Agents and Detergents” (Vol. I and II by Schwartz, Perry and Berch). A variety of such surfactants are also generally disclosed in U.S. Pat. No. 3,929,678, issued Dec. 30, 1975 to Laughlin, et al. at Column 23, line 58 through Column 29, line 23 (herein incorporated by reference).

When included therein, the laundry detergent compositions of the present invention typically comprise from about 1% to about 40%, preferably from about 3% to about 20% by weight of such anionic surfactants.

Highly preferred anionic surfactants include alkyl alkoxylated sulfate surfactants hereof are water soluble salts or acids of the formula RO(A)ₘSO3M wherein R is an unsubstituted C₁₀-C₂₄ alkyl or hydroxyalkyl group having a C₁₀-C₂₄ alkyl component, preferably a C₁₂-C₂₀ alkyl or hydroxyalkyl, more preferably C₁₂-C₁₈ alkyl or hydroxyalkyl, A is an ethoxy or propoxy unit, m is greater than zero, typically between about 0.5 and about 6, more preferably between about 0.5 and about 3, and M is H or a cation which can be, for example, a metal cation (e.g., sodium, potassium, lithium, calcium, magnesium, etc.), ammonium or substituted-ammonium cation. Alkyl ethoxylated sulfates as well as alkyl propoxylated sulfates are contemplated herein. Specific examples of substituted ammonium cations include methyl-, dimethyl, trimethyl-ammonium cations and quaternary ammonium cations such as tetramethyl-ammonium and dimethyl piperdinium cations and those derived from alkylamines such as ethylamine, diethylamine, triethylamine, mixtures thereof, and the like. Exemplary surfactants are C₁₂-C₁₈ alkyl polyethoxylate (1.0) sulfate (C₁₂-C₁₈E(1.0)M), C₁₂-C₁₈ alkyl polyethoxylate (2.25) sulfate (C₁₂-C₁₈E(2.25)M), C₁₂-C₁₈ alkyl polyethoxylate (3.0) sulfate (C₁₂-C₁₈E(3.0)M), and C₁₂-C₁₈ alkyl polyethoxylate (4.0) sulfate (C₁₂-C₁₈E(4.0)M), wherein M is conveniently selected from sodium and potassium.

Cationic Surfactants

Cationic surfactants suitable for use in the detergent compositions of the present invention are those having one long-chain hydrocarbyl group. Examples of such cationic surfactants include the ammonium surfactants such as alkyltrimethylammonium halogenides, and those surfactants having the formula:

[R²(OR³)_{y}][R⁴(OR³)_{y}]₂R⁵N+X−

wherein R² is an alkyl or alkyl benzyl group having from about 8 to about 18 carbon atoms in the alkyl chain, each R³ is selected from the group consisting of —CH₂CH₂—, —CH₂CH(CH₃)—, —CH₂CH (CH₂OH)—, —CH₂CH₂CH₂—, and mixtures thereof; each R⁴ is selected from the group consisting of C₁-C₄ alkyl, C₁-C₄ hydroxyalkyl, benzyl ring structures formed by joining the two R⁴ groups, —CH₂CHOH—CHOHCOR⁶CHOHCH₂OH wherein R⁶ is any hexose or hexose polymer having a molecular weight less than about 1000, and hydrogen when y is not 0; R⁵ is the same as R⁴ or is an alkyl chain wherein the total number of carbon atoms of R² plus R⁵ is not more than about 18; each y is from 0 to about 10 and the sum of the y values is from 0 to about 15; and X is any compatible anion.

Quaternary ammonium surfactant suitable for the present invention has the formula (I):

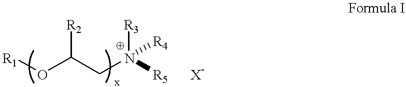

whereby R1 is a short chainlength alkyl (C6-C10) or alkylamidoalkyl of the formula (II):

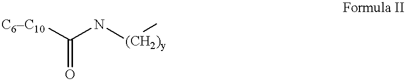

y is 2-4, preferably 3.

whereby R2 is H or a C1-C3 alkyl,

whereby x is 0-4, preferably 0-2, most preferably 0,

whereby R3, R4 and R5 are either the same or different and can be either a short chain alkyl (C1-C3) or alkoxylated alkyl of the formula III,

whereby X⁻ is a counterion, preferably a halide, e.g. chloride or methylsulfate.

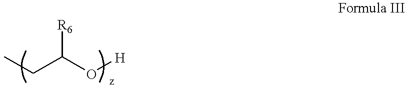

R6 is C₁-C₄ and z is 1 or 2.

Preferred quat ammonium surfactants are those as defined in formula I whereby

R₁ is C₈, C₁₀ or mixtures thereof, x═o,

R₃, R₄═CH₃ and R₅═CH₂CH₂OH.

Highly preferred cationic surfactants are the water-soluble quaternary ammonium compounds useful in the present composition having the formula:

R₁R₂R₃R₄N⁺X⁻ (i)

wherein R₁ is C₈-C₁₆ alkyl, each of R₂, R₃ and R₄ is independently C₁ -C₄ alkyl, C₁-C₄ hydroxy alkyl, benzyl, and —(C₂H₄₀)ₓH where x has a value from 2 to 5, and X is an anion. Not more than one of R₂, R₃ or R₄ should be benzyl. The preferred alkyl chain length for R₁ is C₁₂-C₁₅ particularly where the alkyl group is a mixture of chain lengths derived from coconut or palm kernel fat or is derived synthetically by olefin build up or OXO alcohols synthesis. Preferred groups for R₂R₃ and R₄ are methyl and hydroxyethyl groups and the anion X may be selected from halide, methosulphate, acetate and phosphate ions.

Examples of suitable quaternary ammonium compounds of formulae (i) for use herein are:

coconut trimethyl ammonium chloride or bromide;

coconut methyl dihydroxyethyl ammonium chloride or bromide;

decyl triethyl ammonium chloride;

decyl dimethyl hydroxyethyl ammonium chloride or bromide;

C₁₂₋₁₅ dimethyl hydroxyethyl ammonium chloride or bromide;

coconut dimethyl hydroxyethyl ammonium chloride or bromide;

myristyl trimethyl ammonium methyl sulphate;

lauryl dimethyl benzyl ammonium chloride or bromide;

lauryl dimethyl (ethenoxy)₄ ammonium chloride or bromide;

choline esters (compounds of formula (i) wherein R₁ is

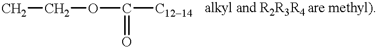

di-alkyl imidazolines [compounds of formula (i)].

Other cationic surfactants useful herein are also described in U.S. Pat. No. 4,228,044, Cambre, issued Oct. 14, 1980 and in European Patent Application EP 000,224.

Typical cationic fabric softening components include the water-insoluble quaternary-ammonium fabric softening actives or their corresponding amine precursor, the most commonly used having been di-long alkyl chain ammonium chloride or methyl sulfate.

Preferred cationic softeners among these include the following:

1) ditallow dimethylammonium chloride (DTDMAC);

2) dihydrogenated tallow dimethylammonium chloride;

3) dihydrogenated tallow dimethylammonium methylsulfate;

4) distearyl dimethylammonium chloride;

5) dioleyl dimethylammonium chloride;

6) dipalmityl hydroxyethyl methylammonium chloride;

7) stearyl benzyl dimethylammonium chloride;

8) tallow trimethylammonium chloride;

9) hydrogenated tallow trimethylammonium chloride;

10) C₁₂-₁₄ alkyl hydroxyethyl dimethylammonium chloride;

11) C₁₂₋₁₈ alkyl dihydroxyethyl methylammonium chloride;

12) di(stearoyloxyethyl) dimethylammonium chloride (DSOEDMAC);

13) di(tallow-oxy-ethyl) dimethylammonium chloride;

14) ditallow imidazolinium methylsulfate;

15) 1-(2-tallowylamidoethyl)-2-tallowyl imidazolinium methylsulfate.

Biodegradable quaternary ammonium compounds have been presented as alternatives to the traditionally used di-long alkyl chain ammonium chlorides and methyl sulfates. Such quaternary ammonium compounds contain long chain alk(en)yl groups interrupted by functional groups such as carboxy groups. Said materials and fabric softening compositions containing them are disclosed in numerous publications such as EP-A-0,040,562, and EP-A-0,239,910.

The quaternary ammonium compounds and amine precursors herein have the formula (I) or (II), below:

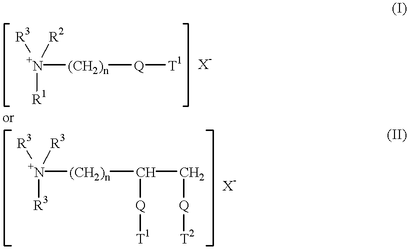

wherein Q is selected from —O—C(O)—, —C(O)—O—, —O—C(O)—O—, —NR⁴—C(O)—, —C(O)—NR⁴—;

R¹ is (CH₂)ₙ—Q—T² or T³;

R² is (CH₂)ₘ—Q—T⁴ or T⁵ or R³;

R³ is C₁-C₄ alkyl or C₁-C₄ hydroxyalkyl or H;

R⁴ is H or C₁-C₄ alkyl or C₁-C₄ hydroxyalkyl;

T¹, T², T³, T⁴, T⁵ are independently C₁₁-C₂₂ alkyl or alkenyl;

n and m are integers from 1 to 4; and

X⁻ is a softener-compatible anion. Non-limiting examples of softener-compatible anions include chloride or methyl sulfate.

The alkyl, or alkenyl, chain T¹, T², T³, T⁴, T⁵ must contain at least 11 carbon atoms, preferably at least 16 carbon atoms. The chain may be straight or branched. Tallow is a convenient and inexpensive source of long chain alkyl and alkenyl material. The compounds wherein T¹, T², T³, T⁴, T⁵ represents the mixture of long chain materials typical for tallow are particularly preferred.

Specific examples of quaternary ammonium compounds suitable for use in the aqueous fabric softening compositions herein include:

1) N,N-di(tallowyl-oxy-ethyl)-N,N-dimethyl ammonium chloride;

2) N,N-di(tallowyl-oxy-ethyl)-N-methyl, N-(2-hydroxyethyl) ammonium methyl sulfate;

3) N,N-di(2-tallowyl-oxy-2-oxo-ethyl)-N,N-dimethyl ammonium chloride;

4) N,N-di(2-tallowyl-oxy-ethylcarbonyl-oxy-ethyl)-N,N-dimethyl ammonium chloride;

5) N-(2-tallowyl-oxy-2-ethyl)-N-(2-tallowyl-oxy-2-oxo-ethyl)-N,N-dimethyl ammonium chloride;

6) N, N, N-tri(tallowyl-oxy-ethyl)-N-methyl ammonium chloride;

7) N-(2-tallowyl-oxy-2-oxo-ethyl)-N-(tallowyl-N,N-dimethyl-ammonium chloride; and

8) 1,2-ditallowyl-oxy-3-trimethylammoniopropane chloride;

and mixtures of any of the above materials.

When included therein, the detergent compositions of the present invention typically comprise from 0.2% to about 25%, preferably from about 1% to about 8% by weight of such cationic surfactants.

Ampholytic Surfactants

Ampholytic surfactants are also suitable for use in the detergent compositions of the present invention. These surfactants can be broadly described as aliphatic derivatives of secondary or tertiary amines, or aliphatic derivatives of heterocyclic secondary and tertiary amines in which the aliphatic radical can be straight- or branched-chain. One of the aliphatic substituents contains at least about 8 carbon atoms, typically from about 8 to about 18 carbon atoms, and at least one contains an anionic water-solubilizing group, e.g. carboxy, sulfonate, sulfate. See U.S. Pat. No. 3,929,678 to Laughlin et al., issued Dec. 30, 1975 at column 19, lines 18-35, for examples of ampholytic surfactants.

When included therein, the detergent compositions of the present invention typically comprise from 0.2% to about 15%, preferably from about 1% to about 10% by weight of such ampholytic surfactants.

Zwitterionic Surfactants

Zwitterionic surfactants are also suitable for use in detergent compositions. These surfactants can be broadly described as derivatives of secondary and tertiary amines, derivatives of heterocyclic secondary and tertiary amines, or derivatives of quaternary ammonium, quaternary phosphonium or tertiary sulfonium compounds. See U.S. Pat. No. 3,929,678 to Laughlin et al., issued Dec. 30, 1975 at column 19, line 38 through column 22, line 48, for examples of zwitterionic surfactants.

When included therein, the detergent compositions of the present invention typically comprise from 0.2% to about 15%, preferably from about 1% to about 10% by weight of such zwitterionic surfactants.

Conventional Detergent Enzymes

The detergent compositions of the present invention can comprise in addition to the maltogenic alpha-amylase, one or more enzymes which provide cleaning performance, fabric care and/or sanitisation benefits. Said enzymes include enzymes selected from cellulases, hemicellulases, peroxidases, proteases, gluco-amylases, amylases, mannanases, xyloglucanases, xylanases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, laccase or mixtures thereof.

Preferably, the detergent compositions of the present invention will comprise an enzyme selected from a lipase, an α-amylase, a cyclomaltodextrin glucanotransferase and/or an amyloglucosidase. Indeed, it has been found that the combination of the maltogenic alpha-amylase and the selected detergent ingredient, with an alpha-amylase, a cyclomaltodextrin glucanotransferase and/or an amyloglucosidase within the detergent compositions of the present invention, provides an improved removal of raw and/or retrograded starch. Furthermore, the stains most commonly encountered in laundry, dishwashing and hard surface cleaning, generally comprise a significant amount of proteins and triglyceride compounds. In particular, it has been found that starch materials are usually associated with lipid compounds. Therefore, it has been found that the combination of a maltogenic alpha-amylase, a detergent ingredient selected from a nonionic surfactant, a protease enzyme and/or a bleaching agent—preferably a nonionic surfactant, with a lipase within the detergent compositions of the present invention, provides an improved removal of such complex stains.

Hence, the detergent compositions comprising such combination of enzymes provide enhanced removal of starch-containing stains and soils and when formulated as a laundry detergent composition, enhanced whiteness maintenance and dingy cleaning.

Alpha-amylase

As indicated above, the detergent compositions of the present invention will preferably comprise an α-amylase. Suitable α-amylases for the purpose of the present invention are described in the following : WO94/02597, Novo Nordisk A/S published Feb. 03, 1994, describes cleaning compositions which incorporate mutant amylases. See also WO95/10603, Novo Nordisk A/S, published Apr. 20, 1995. Other amylases known for use in cleaning compositions include both α-and β-amylases. (α-Amylases are known in the art and include those disclosed in U.S. Pat. No. 5,003,257; EP 252,666; WO/91/00353; FR 2,676,456; EP 285,123; EP 525,610; EP 368,341; and British Patent specification no. 1,296,839 (Novo). Other suitable amylases are stability-enhanced amylases described in WO94/18314, published Aug. 18, 1994 and WO96/05295, Genencor, published Feb. 22, 1996 and amylase variants having additional modification in the immediate parent available from Novo Nordisk A/S, disclosed in WO 95/10603, published April 95. Also suitable are amylases described in EP 277 216, WO95/26397 and WO96/23873 (all by Novo Nordisk). Examples of commercial α-amylases products are Purafect Ox Am® from Genencor and Termamyl®, Ban®, Fungamyl® and Duramyl®, all available from Novo Nordisk A/S Denmark. WO95/26397 describes other suitable amylases: α-amylases characterised by having a specific activity at least 25% higher than the specific activity of Termamyl® at a temperature range of 25° C. to 55° C. and at a pH value in the range of 8 to 10, measured by the Phadebas® α-amylase activity assay. Preferred are variants of the above enzymes, described in WO96/23873 (Novo Nordisk). Preferably, the variants are those demonstrating improved thermal stability, more preferably those wherein at least one amino acid residue equivalent to F180, R181, G182, T183, G184, or K185 has been deleted from the parent α-amylase. Particularly preferred are those variants having improved thermal stabilitywhich comprise the amino acid deletions R181^{*}+G182^{*} or T183^{*}+G184^{*}. Other amylolytic enzymes with improved properties with respect to the activity level and the combination of thermal stability and a higher activity level are described in WO95/35382. Further suitable amylases are the H mutant α-amylase enzymes exhibiting improved stability described in WO98/26078 by Genencor.

The amylolytic enzymes are incorporated in the detergent compositions of the present invention a level of from 0.0001% to 2%, preferably from 0.00018% to 0.06%, more preferably from 0.00024% to 0.048% pure enzyme by weight of the composition.

Cyclomaltodextrin Glucanotransferase

Also preferred is the cyclomaltodextrin glucanotransferase, EC 2.4.1.19, which is an enzyme that cyclizes part of a 1,4-α-D-glucan chain by formation of a 1,4-α-D-glucosidic bond and has the systematic name of 1,4-α-D-glucan 4-α-D-(1,4-α-D-glucano)-transferase (cyclizing). Commercially available cyclomaltodextrin glucanotransferase enzymes are sold under the tradenames CGT-ase by Amano; EN301 by Hayashibara and Toruzyme by Novo Nordisk A/S.

The cyclomaltodextrin glucanotransferase is generally comprised in the detergent composition of the invention in an amount of 0.0001% to 10% by weight, preferably 0.001% to 0.5% by weight.

Amyloglucosidase

Also preferred are the amyloglucosidases classified under the IUPAC Classification as EC 3.2.1.3. Such amyloglucosidase is a glucan 1,4-α-glucosidase; is also referred to as “glucoamylase, γ-amylase, lysosomal α-glucosidase, acid maltase or exo-1,4-α-glucosidase” and its systematic name is 1,4-α-D-glucan glucohydrolase. Suitable amyloglucosidase are described in WO92/00381, WO0/04136 and WO99/28448. Commercially available amyloglucosidases are the enzyme products sold under the tradename PALKODEX by MAPS; AMG300L by Novo Nordisk A/S, Optimax 7525 (Combinations of enzymes including amyloglucosidase) and Spezyme by Genencor. Further commercial available amyloglucosidases are those from Aspergillus niger obtainable from the following companies: Ambazyme, Amano, Boehringer, Fluka, Sigma, Aldomax, Genzyme, Nagase, UOP. Also suitable are the amyloglucosidases from Aspergillus species from the companies Biocatalysts or Danisco and the amyloglucosidases from Rhizopus delemar from Nagase; from Rhizopus niveus from Amano, ICN, Seikagaku; from Rhizopus oryzae from Enzyme Development Co-operation.

Also preferred are lipases. Suitable lipase enzymes include those produced by microorganisms of the Pseudomonas group, such as Pseudomonas stutzeri ATCC 19.154, as disclosed in British Patent 1,372,034. Suitable lipases include those which show a positive immunological cross-reaction with the antibody of the lipase, produced by the microorganism Pseudomonas fluorescent IAM 1057. This lipase is available from Amano Pharmaceutical Co. Ltd., Nagoya, Japan, under the trade name Lipase P “Amano,” hereinafter referred to as “Amano-P”. Other suitable commercial lipases include Amano—CES, lipases ex Chromobacter viscosum, e.g. Chromobacter viscosum var. lipolyticum NRRLB 3673 from Toyo Jozo Co., Tagata, Japan; Chromobacter viscosum lipases from U.S. Biochemical Corp., U.S.A. and Disoynth Co., The Netherlands, and lipases ex Pseudomonas gladioli. Especially suitable lipases are lipases such as M1 Lipase^{R} and Lipomax^{R} (Gist-Brocades) and Lipolase^{R} and Lipolase Ultra^{R}(Novo) which have found to be very effective when used in combination with the compositions of the present invention. Also suitables are the lipolytic enzymes described in EP 258 068, WO 92/05249 and WO 95/22615 by Novo Nordisk and in WO 94/03578, WO 95/35381 and WO 96/00292 by Unilever.

Also suitable are cutinases [EC 3.1.1.50] which can be considered as a special kind of lipase, namely lipases which do not require interfacial activation. Addition of cutinases to detergent compositions have been described in e.g. WO-A-88/09367 (Genencor); WO 90/09446 (Plant Genetic System) and WO 94/14963 and WO 94/14964 (Unilever).

The lipases and/or cutinases are normally incorporated in the detergent composition at levels from 0.0001% to 2% of pure enzyme by weight of the detergent composition.

The cellulases usable in the present invention include both bacterial or fungal cellulases. Preferably, they will have a pH optimum of between 5 and 12 and a specific activity above 50 CEVU/mg (Cellulose Viscosity Unit). Suitable cellulases are disclosed in U.S. Pat. No. 4,435,307, Barbesgoard et al, J61078384 and WO96/02653 which discloses fungal cellulase produced respectively from Humicola insolens, Trichoderma, Thielavia and Sporotrichum. EP 739 982 describes cellulases isolated from novel Bacillus species. Suitable cellulases are also disclosed in GB-A-2.075.028; GB-A-2.095.275; DE—OS-2.247.832 and WO95/26398.

Examples of such cellulases are cellulases produced by a strain of Humicola insolens (Humicola grisea var. thermoidea), particularly the Humicola strain DSM 1800.

Other suitable cellulases are cellulases originated from Humicola insolens having a molecular weight of about 50 KDa, an isoelectric point of 5.5 and containing 415 amino acids; and a ^{˜}43 kD endoglucanase derived from Humicola insolens, DSM 1800, exhibiting cellulase activity; a preferred endoglucanase component has the amino acid sequence disclosed in PCT Patent Application No. WO 91/17243.

Also suitable cellulases are the EGIII cellulases from Trichoderma longibrachiatum described in WO94/21801, Genencor, published Sep. 29, 1994. Especially suitable cellulases are the cellulases having color care benefits. Examples of such cellulases are cellulases described in European patent application No. 91202879.2, filed Nov. 6, 1991 (Novo). Carezyme and Celluzyme (Novo Nordisk A/S) are especially useful. See also WO91/17244 and WO91/21801. Other suitable cellulases for fabric care and/or cleaning properties are described in WO96/34092, WO96/17994 and WO95/24471.

Said cellulases are normally incorporated in the detergent composition at levels from 0.0001% to 2% of pure enzyme by weight of the detergent composition.

Peroxidase enzymes are used in combination with oxygen sources, e.g. percarbonate, perborate, persulfate, hydrogen peroxide, etc and with a phenolic substrate as bleach enhancing molecule. They are used for “solution bleaching”, i.e. to prevent transfer of dyes or pigments removed from substrates during wash operations to other substrates in the wash solution. Peroxidase enzymes are known in the art, and include, for example, horseradish peroxidase, ligninase and haloperoxidase such as chloro- and bromo-peroxidase. Peroxidase-containing detergent compositions are disclosed, for example, in PCT International Application WO 89/099813, WO 89/09813 and in European Patent application EP No. 91202882.6, filed on Nov. 6, 1991 and EP No. 96870013.8, filed Feb. 20, 1996. Also suitable is the laccase enzyme.

Enhancers are generally comprised at a level of from 0.1% to 5% by weight of total composition. Preferred enhancers are substitued phenthiazine and phenoxasine 10-Phenothiazinepropionicacid (PPT), 10-ethylphenothiazine-4-carboxylic acid (EPC), 10-phenoxazinepropionic acid (POP) and 10-methylphenoxazine (described in WO 94/12621) and substitued syringates (C3-C5 substitued alkyl syringates) and phenols. Sodium percarbonate or perborate are preferred sources of hydrogen peroxide.

Said peroxidases are normally incorporated in the detergent composition at levels from 0.0001% to 2% of pure enzyme by weight of the detergent composition.

The above-mentioned enzymes may be of any suitable origin, such as vegetable, animal, bacterial, fungal and yeast origin. Origin can further be mesophilic or extremophilic (psychrophilic, psychrotrophic, thermophilic, barophilic, alkalophilic, acidophilic, halophilic, etc.). Purified or non-purified forms of these enzymes may be used. Nowadays, it is common practice to modify wild-type enzymes via protein/genetic engineering techniques in order to optimise their performance efficiency in the detergent compositions of the invention. For example, the variants may be designed such that the compatibility of the enzyme to commonly encountered ingredients of such compositions is increased. Alternatively, the variant may be designed such that the optimal pH, bleach or chelant stability, catalytic activity and the like, of the enzyme variant is tailored to suit the particular cleaning application.

In particular, attention should be focused on amino acids sensitive to oxidation in the case of bleach stability and on surface charges for the surfactant compatibility. The isoelectric point of such enzymes may be modified by the substitution of some charged amino acids, e.g. an increase in isoelectric point may help to improve compatibility with anionic surfactants. The stability of the enzymes may be further enhanced by the creation of e.g. additional salt bridges and enforcing calcium binding sites to increase chelant stability. Special attention must be paid to the cellulases as most of the cellulases have separate binding domains (CBD). Properties of such enzymes can be altered by modifications in these domains.

The enzymes can be added as separate single ingredients (prills, granulates, stabilized liquids, etc. . . containing one enzyme) or as mixtures of two or more enzymes (e.g. cogranulates).

Other suitable detergent ingredients that can be added are enzyme oxidation scavengers which are described in Copending European Patent application 92870018.6 filed on Jan. 31, 1992. Examples of such enzyme oxidation scavengers are ethoxylated tetraethylene polyamines.

A range of enzyme materials and means for their incorporation into synthetic detergent compositions is also disclosed in WO 9307263 A and WO 9307260 A to Genencor International, WO 8908694 A to Novo, and U.S. Pat. No. 3,553,139, Jan. 5, 1971 to McCarty et al. Enzymes are further disclosed in U.S. Pat. No. 4,101,457, Place et al, Jul. 18, 1978, and in U.S. Pat. No. 4,507,219, Hughes, Mar. 26, 1985. Enzyme materials useful for liquid detergent formulations, and their incorporation into such formulations, are disclosed in U.S. Pat. No. 4,261,868, Hora et al, Apr. 14, 1981. Enzymes for use in detergents can be stabilised by various techniques. Enzyme stabilisation techniques are disclosed and exemplified in U.S. Pat. No. 3,600,319, Aug. 17, 1971, Gedge et al, EP 199,405 and EP 200,586, Oct. 29, 1986, Venegas. Enzyme stabilisation systems are also described, for example, in U.S. Pat. No. 3,519,570.

A useful Bacillus, sp. AC13 giving proteases, xylanases and cellulases, is described in WO 9401532 A to Novo.

Colour Care and Fabric Care Benefits

Technologies which provide a type of colour care benefit can also be included. Examples of these technologies are metallo catalysts for colour maintenance. Such metallo catalysts are described in copending European Patent Application No. 92870181.2. Dye fixing agents, polyolefin dispersion for anti-wrinkles and improved water absorbancy, perfume and amino-functional polymer (PCT/US97/16546) for colour care treatment and perfume substantivity are further examples of colour care/fabric care technologies and are described in the co-pending patent application Ser. No. 96870140.9, filed Nov. 7, 1996.

Fabric softening agents can also be incorporated into detergent compositions in accordance with the present invention. These agents may be inorganic or organic in type. Inorganic softening agents are exemplified by the smectite clays disclosed in GB-A-1 400 898 and in U.S. Pat. No. 5,019,292. Organic fabric softening agents include the water insoluble tertiary amines as disclosed in GB-A1 514 276 and EP-BO 011 340 and their combination with mono C12-C14 quaternary ammonium salts are disclosed in EP-B-0 026 527 and EP-B-0 026 528 and di-long-chain amides as disclosed in EP-B-0 242 919. Other useful organic ingredients of fabric softening systems include high molecular weight polyethylene oxide materials as disclosed in EP-A-0 299 575 and 0 313 146.

Levels of smectite clay are normally in the range from 2% to 20%, more preferably from 5% to 15% by weight, with the material being added as a dry mixed component to the remainder of the formulation. Organic fabric softening agents such as the water-insoluble tertiary amines or dilong chain amide materials are incorporated at levels of from 0.5% to 5% by weight, normally from 1% to 3% by weight whilst the high molecular weight polyethylene oxide materials and the water soluble cationic materials are added at levels of from 0.1% to 2%, normally from 0.15% to 1.5% by weight. These materials are normally added to the spray dried portion of the composition, although in some instances it may be more convenient to add them as a dry mixed particulate, or spray them as molten liquid on to other solid components of the composition.

Builder System

The compositions according to the present invention may further comprise a builder system. Any conventional builder system is suitable for use herein including aluminosilicate materials, silicates, polycarboxylates, alkyl- or alkenyl-succinic acid and fatty acids, materials such as ethylenediamine tetraacetate, diethylene triamine pentamethyleneacetate, metal ion sequestrants such as aminopolyphosphonates, particularly ethylenediamine tetramethylene phosphonic acid and diethylene triamine pentamethylenephosphonic acid. Phosphate builders can also be used herein.

Suitable builders can be an inorganic ion exchange material, commonly an inorganic hydrated aluminosilicate material, more particularly a hydrated synthetic zeolite such as hydrated zeolite A, X, B, HS or MAP.

Another suitable inorganic builder material is layered silicate, e.g. SKS-6 (Hoechst). SKS-6 is a crystalline layered silicate consisting of sodium silicate (Na₂Si₂O₅).

Suitable polycarboxylates containing one carboxy group include lactic acid, glycolic acid and ether derivatives thereof as disclosed in Belgian Patent Nos. 831,368, 821,369 and 821,370. Polycarboxylates containing two carboxy groups include the water-soluble salts of succinic acid, malonic acid, (ethylenedioxy) diacetic acid, maleic acid, diglycollic acid, tartaric acid, tartronic acid and fumaric acid, as well as the ether carboxylates described in German Offenlegenschrift 2,446,686, and 2,446,687 and U.S. Pat. No. 3,935,257 and the sulfinyl carboxylates described in Belgian Patent No. 840,623. Polycarboxylates containing three carboxy groups include, in particular, water-soluble citrates, aconitrates and citraconates as well as succinate derivatives such as the carboxymethyloxysuccinates described in British Patent No. 1,379,241, lactoxysuccinates described in Netherlands Application 7205873, and the oxypolycarboxylate materials such as 2-oxa-1,1,3-propane tricarboxylates described in British Patent No.1,387,447.

Polycarboxylates containing four carboxy groups include oxydisuccinates disclosed in British Patent No. 1,261,829, 1,1,2,2-ethane tetracarboxylates, 1,1,3,3-propane tetracarboxylates and 1,1,2,3-propane tetracarboxylates. Polycarboxylates containing sulfo substituents include the sulfosuccinate derivatives disclosed in British Patent Nos. 1,398,421 and 1,398,422 and in U.S. Pat. No. 3,936,448, and the sulfonated pyrolysed citrates described in British Patent No. 1,082,179, while polycarboxylates containing phosphone substituents are disclosed in British Patent No.1,439,000.

Alicyclic and heterocyclic polycarboxylates include cyclopentane-cis,cis,cis-tetracarboxylates, cyclopentadienide pentacarboxylates, 2,3,4,5-tetrahydro-furan-cis, cis, cis-tetracarboxylates, 2,5-tetrahydro-furan-cis-dicarboxylates, 2,2,5,5-tetrahydrofuran-tetracarboxylates, 1,2,3,4,5,6-hexane -hexacar-boxylates and and carboxymethyl derivatives of polyhydric alcohols such as sorbitol, mannitol and xylitol. Aromatic poly-carboxylates include mellitic acid, pyromellitic acid and the phthalic acid derivatives disclosed in British Patent No.1,425,343.

Of the above, the preferred polycarboxylates are hydroxycarboxylates containing up to three carboxy groups per molecule, more particularly citrates.

Preferred builder systems for use in the present compositions include a mixture of a water-insoluble aluminosilicate builder such as zeolite A or of a layered silicate (SKS-6), and a water-soluble carboxylate chelating agent such as citric acid. Other preferred builder systems include a mixture of a water-insoluble aluminosilicate builder such as zeolite A, and a watersoluble carboxylate chelating agent such as citric acid. Preferred builder systems for use in liquid detergent compositions of the present invention are soaps and polycarboxylates.

Other builder materials that can form part of the builder system for use in granular compositions include inorganic materials such as alkali metal carbonates, bicarbonates, silicates, and organic materials such as the organic phosphonates, amino polyalkylene phosphonates and amino polycarboxylates.

Other suitable water-soluble organic salts are the homo- or co-polymeric acids or their salts, in which the polycarboxylic acid comprises at least two carboxyl radicals separated from each other by not more than two carbon atoms. Polymers of this type are disclosed in GB-A-1,596,756. Examples of such salts are polyacrylates of MW 2000-5000 and their copolymers with maleic anhydride, such copolymers having a molecular weight of from 20,000 to 70,000, especially about 40,000.

Detergency builder salts are normally included in amounts of from 5% to 80% by weight of the composition preferably from 10% to 70% and most usually from 30% to 60% by weight.

Chelating Agents

The detergent compositions herein may also optionally contain one or more iron and/or manganese chelating agents. Such chelating agents can be selected from the group consisting of amino carboxylates, amino phosphonates, polyfunctionally-substituted aromatic chelating agents and mixtures therein, all as hereinafter defined. Without intending to be bound by theory, it is believed that the benefit of these materials is due in part to their exceptional ability to remove iron and manganese ions from washing solutions by formation of soluble chelates.

Amino carboxylates useful as optional chelating agents include ethylenediaminetetracetates, N-hydroxyethylethylenediaminetriacetates, nitrilotriacetates, ethylenediamine tetraproprionates, triethylenetetraaminehexacetates, diethylenetriaminepentaacetates, and ethanoldiglycines, alkali metal, ammonium, and substituted ammonium salts therein and mixtures therein.

Amino phosphonates are also suitable for use as chelating agents in the compositions of the invention when at lease low levels of total phosphorus are permitted in detergent compositions, and include ethylenediaminetetrakis (methylenephosphonates) as DEQUEST. Preferred, these amino phosphonates to not contain alkyl or alkenyl groups with more than about 6 carbon atoms.

Polyfunctionally-substituted aromatic chelating agents are also useful in the compositions herein. See U.S. Pat. No. 3,812,044, issued May 21, 1974, to Connor et al. Preferred compounds of this type in acid form are dihydroxydisulfobenzenes such as 1,2-dihydroxy-3,5-disulfobenzene.

A preferred biodegradable chelator for use herein is ethylenediamine disuccinate (“EDDS”), especially the [S,S] isomer as described in U.S. Pat. No. 4,704,233, Nov. 3, 1987, to Hartman and Perkins.

The compositions herein may also contain water-soluble methyl glycine diacetic acid (MGDA) salts (or acid form) as a chelant or co-builder useful with, for example, insoluble builders such as zeolites, layered silicates and the like.

If utilized, these chelating agents will generally comprise from about 0.1% to about 15% by weight of the detergent compositions herein. More preferably, if utilized, the chelating agents will comprise from about 0.1% to about 3.0% by weight of such compositions.

Suds Suppressor

Another optional ingredient is a suds suppressor, exemplified by silicones, and silica-silicone mixtures. Silicones can be generally represented by alkylated polysiloxane materials while silica is normally used in finely divided forms exemplified by silica aerogels and xerogels and hydrophobic silicas of various types. These materials can be incorporated as particulates in which the suds suppressor is advantageously releasably incorporated in a water-soluble or water-dispersible, substantially non-surface-active detergent impermeable carrier. Alternatively the suds suppressor can be dissolved or dispersed in a liquid carrier and applied by spraying on to one or more of the other components.

A preferred silicone suds controlling agent is disclosed in Bartollota et al. U.S. Pat. No. 3,933,672. Other particularly useful suds suppressors are the self-emulsifying silicone suds suppressors, described in German Patent Application DTOS 2 646 126 published Apr. 28, 1977. An example of such a compound is DC-544, commercially available from Dow Corning, which is a siloxane-glycol copolymer. Especially preferred suds controlling agent are the suds suppressor system comprising a mixture of silicone oils and 2-alkyl-alcanols. Suitable 2-alkyl-alkanols are 2-butyl-octanol which are commercially available under the trade name Isofol 12 R.

Such suds suppressor system are described in Copending European Patent application N 92870174.7 filed Nov. 10, 1992.

Especially preferred silicone suds controlling agents are described in Copending European Patent application N°92201649.8. Said compositions can comprise a silicone/silica mixture in combination with fumed nonporous silica such as Aerosil^{R}.

The suds suppressors described above are normally employed at levels of from 0.001% to 2% by weight of the composition, preferably from 0.01% to 1% by weight.

Others

Other components used in detergent compositions may be employed, such as soil-suspending agents, soil-release agents, optical brighteners, abrasives, bactericides, tarnish inhibitors, coloring agents, and/or encapsulated or non-encapsulated perfumes.

Especially suitable encapsulating materials are water soluble capsules which consist of a matrix of polysaccharide and polyhydroxy compounds such as described in GB 1,464,616. Other suitable water soluble encapsulating materials comprise dextrins derived from ungelatinized starch acid-esters of substituted dicarboxylic acids such as described in U.S. Pat. No. 3,455,838. These acid-ester dextrins are,preferably, prepared from such starches as waxy maize, waxy sorghum, sago, tapioca and potato. Suitable examples of said encapsulating materials include N-Lok manufactured by National Starch. The N-Lok encapsulating material consists of a modified maize starch and glucose. The starch is modified by adding monofunctional substituted groups such as octenyl succinic acid anhydride.

Antiredeposition and soil suspension agents suitable herein include cellulose derivatives such as methylcellulose, carboxymethylcellulose and hydroxyethylcellulose, and homo- or co-polymeric polycarboxylic acids or their salts. Polymers of this type include the polyacrylates and maleic anhydride-acrylic acid copolymers previously mentioned as builders, as well as copolymers of maleic anhydride with ethylene, methylvinyl ether or methacrylic acid, the maleic anhydride constituting at least 20 mole percent of the copolymer. These materials are normally used at levels of from 0.5% to 10% by weight, more preferably from 0.75% to 8%, most preferably from 1% to 6% by weight of the composition.

Preferred optical brighteners are anionic in character, examples of which are disodium 4,4′-bis-(2-diethanolamino-4-anilino-s-triazin-6-ylamino)stilbene-2:2′ disulphonate, disodium 4,-4′-bis-(2-morpholino-4-anilino-s-triazin-6-ylamino-stilbene-2:2′-disulphonate, disodium 4,4′-bis-(2,4-dianilino-s-triazin-6-ylamino)stilbene-2:2′-disulphonate, monosodium 4′,4″-bis-(2,4-dianilino-s-tri-azin-6 ylamino)stilbene-2-sulphonate, disodium 4,4′-bis-(2-anilino-4-(N-methyl-N-2-hydroxyethylamino)-s-triazin-6-ylamino)stilbene-2,2′-disulphonate, di-sodium 4,4′-bis-(4-phenyl-2,1,3-triazol-2-yl)-stilbene-2,2′disulphonate, di-so-dium 4,4′bis(2-anilino-4-(1-methyl-2-hydroxyethylamino)-s-triazin-6-ylami-no)stilbene-2,2′disulphonate, sodium 2(stilbyl-4″-(naphtho-1′,2′:4,5)-1,2,3 -triazole-2″-sulphonate and 4,4′-bis(2-sulphostyryl)biphenyl. Highly preferred brighteners are the specific brighteners disclosed in EP 753 567.

Other useful polymeric materials are the polyethylene glycols, particularly those of molecular weight 1000-10000, more particularly 2000 to 8000 and most preferably about 4000. These are used at levels of from 0.20% to 5% more preferably from 0.25% to 2.5% by weight. These polymers and the previously mentioned homo- or co-polymeric polycarboxylate salts are valuable for improving whiteness maintenance, fabric ash deposition, and cleaning performance on clay, proteinaceous and oxidizable soils in the presence of transition metal impurities.

Soil release agents useful in compositions of the present invention are conventionally copolymers or terpolymers of terephthalic acid with ethylene glycol and/or propylene glycol units in various arrangements. Examples of such polymers are disclosed in the commonly assigned U.S. Pat. Nos. 4,116,885 and 4,711,730 and European Published Patent Application No. 0 272 033. A particular preferred polymer in accordance with EP-A-0 272 033 has the formula

(CH₃(PEG)₄₃)_{0.75}(POH)_{0.25}[T-PO)_{2.8}(T-PEG)_{0.4}]T(PO-H)_{0.25}((PEG)₄₃CH₃)_{0.75}

where PEG is —(OC₂H₄)O—, PO is (OC₃H₆O) and T is (pcOC₆H₄CO).

Also very useful are modified polyesters as random copolymers of dimethyl terephthalate, dimethyl sulfoisophthalate, ethylene glycol and 1-2 propane diol, the end groups consisting primarily of sulphobenzoate and secondarily of mono esters of ethylene glycol and/or propane-diol. The target is to obtain a polymer capped at both end by sulphobenzoate groups, “primarily”, in the present context most of said copolymers herein will be end-capped by sulphobenzoate groups. However, some copolymers will be less than fully capped, and therefore their end groups may consist of monoester of ethylene glycol and/or propane 1-2 diol, thereof consist “secondarily” of such species.

The selected polyesters herein contain about 46% by weight of dimethyl terephthalic acid, about 16% by weight of propane-1.2 diol, about 10% by weight ethylene glycol about 13% by weight of dimethyl sulfobenzoic acid and about 15% by weight of sulfoisophthalic acid, and have a molecular weight of about 3.000. The polyesters and their method of preparation are described in detail in EPA 311 342.

It is well known in the art that free chlorine in tap water rapidly deactivates the enzymes comprised in detergent compositions. Therefore, using chlorine scavenger such as perborate, ammonium sulfate, sodium sulphite or polyethyleneimine at a level above 0.1% by weight of total composition, in the formulas will provide improved through the wash stability of the detergent enzymes. Compositions comprising chlorine scavenger are described in the European patent application 92870018.6 filed Jan. 31, 1992.

Alkoxylated polycarboxylates such as those prepared from polyacrylates are useful herein to provide additional grease removal performance. Such materials are described in WO 91/08281 and PCT 90/01815 at p. 4 et seq., incorporated herein by reference. Chemically, these materials comprise polyacrylates having one ethoxy side-chain per every 7-8 acrylate units. The side-chains are of the formula —(CH₂CH₂O)ₘ(CH₂)ₙCH₃ wherein m is 2-3 and n is 6-12. The side-chains are ester-linked to the polyacrylate “backbone” to provide a “comb” polymer type structure. The molecular weight can vary, but is typically in the range of about 2000 to about 50,000. Such alkoxylated polycarboxylates can comprise from about 0.05% to about 10%, by weight, of the compositions herein.

Dispersants

The detergent composition of the present invention can also contain dispersants: Suitable water-soluble organic salts are the homo- or co-polymeric acids or their salts, in which the polycarboxylic acid comprises at least two carboxyl radicals separated from each other by not more than two carbon atoms. Polymers of this type are disclosed in GB-A-1,596,756. Examples of such salts are polyacrylates of MW 2000-5000 and their copolymers with maleic anhydride, such copolymers having a molecular weight of from 1,000 to 100,000.

Especially, copolymer of acrylate and methylacrylate such as the 480N having a molecular weight of 4000, at a level from 0.5-20% by weight of composition can be added in the detergent compositions of the present invention.

The compositions of the invention may contain a lime soap peptiser compound, which has preferably a lime soap dispersing power (LSDP), as defined hereinafter of no more than 8, preferably no more than 7, most preferably no more than 6. The lime soap peptiser compound is preferably present at a level from 0% to 20% by weight.

A numerical measure of the effectiveness of a lime soap peptiser is given by the lime soap dispersant power (LSDP) which is determined using the lime soap dispersant test as described in an article by H. C. Borghetty and C. A. Bergman, J. Am. Oil. Chem. Soc., volume 27, pages 88-90, (1950). This lime soap dispersion test method is widely used by practitioners in this art field being referred to, for example, in the following review articles; W. N. Linfield, Surfactant science Series, Volume 7, page 3; W. N. Linfield, Tenside surf. det., volume 27, pages 159-163, (1990); and M. K. Nagarajan, W. F. Masler, Cosmetics and Toiletries, volume 104, pages 71-73, (1989). The LSDP is the % weight ratio of dispersing agent to sodium oleate required to disperse the lime soap deposits formed by 0.025 g of sodium oleate in 30 ml of water of 333 ppm CaCo₃ (Ca:Mg =3:2) equivalent hardness.

Surfactants having good lime soap peptiser capability will include certain amine oxides, betaines, sulfobetaines, alkyl ethoxysulfates and ethoxylated alcohols.

Exemplary surfactants having a LSDP of no more than 8 for use in accord with the present invention include C₁₆-C₁₈ dimethyl amine oxide, C₁₂-C₁₈ alkyl ethoxysulfates with an average degree of ethoxylation of from 1-5, particularly C₁₂-C₁₅ alkyl ethoxysulfate surfactant with a degree of ethoxylation of amount 3 (LSDP=4), and the C₁₄-C₁₅ ethoxylated alcohols with an average degree of ethoxylation of either 12 (LSDP=6) or 30, sold under the tradenames Lutensol A012 and Lutensol A030 respectively, by BASF GmbH.

Polymeric lime soap peptisers suitable for use herein are described in the article by M. K. Nagarajan, W. F. Masler, to be found in Cosmetics and Toiletries, volume 104, pages 71-73, (1989).

Hydrophobic bleaches such as 4-[N-octanoyl-6-aminohexanoyl]benzene sulfonate, 4-[N-nonanoyl-6-aminohexanoyl]benzene sulfonate, 4-[N-decanoyl-6-aminohexanoyl]benzene sulfonate and mixtures thereof; and nonanoyloxy benzene sulfonate together with hydrophilic/hydrophobic bleach formulations can also be used as lime soap peptisers compounds.

Dye Transfer Inhibition

The detergent compositions of the present invention can also include compounds for inhibiting dye transfer from one fabric to another of solubilized and suspended dyes encountered during fabric laundering operations involving colored fabrics.

Polymeric Dye Transfer Inhibiting Agents

The detergent compositions according to the present invention also comprise from 0.001% to 10%, preferably from 0.01% to 2%, more preferably from 0.05% to 1% by weight of polymeric dye transfer inhibiting agents. Said polymeric dye transfer inhibiting agents are normally incorporated into detergent compositions in order to inhibit the transfer of dyes from colored fabrics onto fabrics washed therewith. These polymers have the ability to complex or adsorb the fugitive dyes washed out of dyed fabrics before the dyes have the opportunity to become attached to other articles in the wash.

Especially suitable polymeric dye transfer inhibiting agents are polyamine N-oxide polymers, copolymers of N-vinylpyrrolidone and N-vinylimidazole, polyvinylpyrrolidone polymers, polyvinyloxazolidones and polyvinylimidazoles or mixtures thereof.

Addition of such polymers also enhances the performance of the enzymes according the invention.

a) Polyamine N-oxide polymers

The polyamine N-oxide polymers suitable for use contain units having the following structure formula:

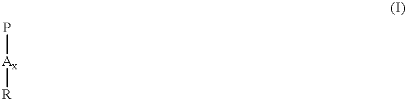

wherein

P is a polymerisable unit, whereto the R—N—O group can be attached to or wherein the R—N—O group forms part of the polymerisable unit or a combination of both.

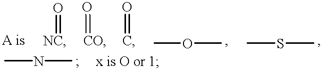

R are aliphatic, ethoxylated aliphatics, aromatic, heterocyclic or alicyclic groups or any combination thereof whereto the nitrogen of the N—O group can be attached or wherein the nitrogen of the N—O group is part of these groups.

The N—O group can be represented by the following general structures:

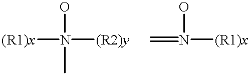

(R3)z

wherein

R1, R2, and R3 are aliphatic groups, aromatic, heterocyclic or alicyclic groups or combinations thereof, x or/and y or/and z is 0 or 1 and wherein the nitrogen of the N—O group can be attached or wherein the nitrogen of the N—O group forms part of these groups.

The N—O group can be part of the polymerisable unit (P) or can be attached to the polymeric backbone or a combination of both.

Suitable polyamine N-oxides wherein the N—O group forms part of the polymerisable unit comprise polyamine N-oxides wherein R is selected from aliphatic, aromatic, alicyclic or heterocyclic groups.

One class of said polyamine N-oxides comprises the group of polyamine N-oxides wherein the nitrogen of the N—O group forms part of the R-group. Preferred polyamine N-oxides are those wherein R is a heterocyclic group such as pyrridine, pyrrole, imidazole, pyrrolidine, piperidine, quinoline, acridine and derivatives thereof.

Another class of said polyamine N-oxides comprises the group of polyamine N-oxides wherein the nitrogen of the N—O group is attached to the R-group.

Other suitable polyamine N-oxides are the polyamine oxides whereto the N—O group is attached to the polymerisable unit.

Preferred class of these polyamine N-oxides are the polyamine N-oxides having the general formula (I) wherein R is an aromatic, heterocyclic or alicyclic groups wherein the nitrogen of the N—O functional group is part of said R group.

Examples of these classes are polyamine oxides wherein R is a heterocyclic compound such as pyrridine, pyrrole, imidazole and derivatives thereof.

Another preferred class of polyamine N-oxides are the polyamine oxides having the general formula (I) wherein R are aromatic, heterocyclic or alicyclic groups wherein the nitrogen of the N—O functional group is attached to said R groups.

Examples of these classes are polyamine oxides wherein R groups can be aromatic such as phenyl.

Any polymer backbone can be used as long as the amine oxide polymer formed is water-soluble and has dye transfer inhibiting properties. Examples of suitable polymeric backbones are polyvinyls, polyalkylenes, polyesters, polyethers, polyamide, polyimides, polyacrylates and mixtures thereof.

The amine N-oxide polymers of the present invention typically have a ratio of amine to the amine N-oxide of 10:1 to 1:1000000. However the amount of amine oxide groups present in the polyamine oxide polymer can be varied by appropriate copolymerization or by appropriate degree of N-oxidation. Preferably, the ratio of amine to amine N-oxide is from 2:3 to 1:1000000. More preferably from 1:4 to 1:1000000, most preferably from 1:7 to 1:1000000. The polymers of the present invention actually encompass random or block copolymers where one monomer type is an amine N-oxide and the other monomer type is either an amine N-oxide or not. The amine oxide unit of the polyamine N-oxides has a PKa<10, preferably PKa<7, more preferred PKa<6.

The polyamine oxides can be obtained in almost any degree of polymerisation.

The degree of polymerisation is not critical provided the material has the desired water-solubility and dye-suspending power.

Typically, the average molecular weight is within the range of 500 to 1000,000; preferably from 1,000 to 50,000, more preferably from 2,000 to 30,000, most preferably from 3,000 to 20,000.

b) Copolymers of N-vinylpyrrolidone and N-vinylimidazole

The N-vinylimidazole N-vinylpyrrolidone polymers used in the present invention have an average molecular weight range from 5,000-1,000,000, preferably from 5,000-200,000.

Highly preferred polymers for use in detergent compositions according to the present invention comprise a polymer selected from N-vinylimidazole N-vinylpyrrolidone copolymers wherein said polymer has an average molecular weight range from 5,000 to 50,000 more preferably from 8,000 to 30,000, most preferably from 10,000 to 20,000.

The average molecular weight range was determined by light scattering as described in Barth H. G. and Mays J. W. Chemical Analysis Vol 113,“Modern Methods of Polymer Characterization”.

Highly preferred N-vinylimidazole N-vinylpyrrolidone copolymers have an average molecular weight range from 5,000 to 50,000; more preferably from 8,000 to 30,000; most preferably from 10,000 to 20,000.

The N-vinylimidazole N-vinylpyrrolidone copolymers characterized by having said average molecular weight range provide excellent dye transfer inhibiting properties while not adversely affecting the cleaning performance of detergent compositions formulated therewith.

The N-vinylimidazole N-vinylpyrrolidone copolymer of the present invention has a molar ratio of N-vinylimidazole to N-vinylpyrrolidone from 1 to 0.2, more preferably from 0.8 to 0.3, most preferably from 0.6 to 0.4.

c) Polyvinylpyrrolidone

The detergent compositions of the present invention may also utilize polyvinylpyrrolidone (“PVP”) having an average molecular weight of from about 2,500 to about 400,000, preferably from about 5,000 to about 200,000, more preferably from about 5,000 to about 50,000, and most preferably from about 5,000 to about 15,000. Suitable polyvinylpyrrolidones are commercially vailable from ISP Corporation, New York, N.Y. and Montreal, Canada under the product names PVP K-15 (viscosity molecular weight of 10,000), PVP K-30 (average molecular weight of 40,000), PVP K-60 (average molecular weight of 160,000), and PVP K-90 (average molecular weight of 360,000). Other suitable polyvinylpyrrolidones which are commercially available from BASF Cooperation include Sokalan HP 165 and Sokalan HP 12; polyvinylpyrrolidones known to persons skilled in the detergent field (see for example EP-A-262,897 and EP-A-256,696).

d) Polyvinyloxazolidone

The detergent compositions of the present invention may also utilize polyvinyloxazolidone as a polymeric dye transfer inhibiting agent. Said polyvinyloxazolidones have an average molecular weight of from about 2,500 to about 400,000, preferably from about 5,000 to about 200,000, more preferably from about 5,000 to about 50,000, and most preferably from about 5,000 to about 15,000.

e) Polyvinylimidazole

The detergent compositions of the present invention may also utilize polyvinylimidazole as polymeric dye transfer inhibiting agent. Said polyvinylimidazoles have an average about 2,500 to about 400,000, preferably from about 5,000 to about 200,000, more preferably from about 5,000 to about 50,000, and most preferably from about 5,000 to about 15,000.

f) Cross-linked polymers

Cross-linked polymers are polymers whose backbone are interconnected to a certain degree; these links can be of chemical or physical nature, possibly with active groups n the backbone or on branches; cross-linked polymers have been described in the Journal of Polymer Science, volume 22, pages 1035-1039.

In one embodiment, the cross-linked polymers are made in such a way that they form a three-dimensional rigid structure, which can entrap dyes in the pores formed by the three-dimensional structure. In another embodiment, the cross-linked polymers entrap the dyes by swelling. Such cross-linked polymers are described in the co-pending patent application 94870213.9

Method of Washing

The compositions of the invention may be used in essentially any washing or cleaning methods, including soaking methods, pretreatment methods and methods with rinsing steps for which a separate rinse aid composition may be added.

The process described herein comprises contacting fabrics, dishware or any other hard surface with a cleaning solution in the usual manner and exemplified hereunder. A conventional laundry method comprises treating soiled fabric with an aqueous liquid having dissolved or dispensed therein an effective amount of the laundry detergent and/or fabric care composition. A preferred machine dishwashing method comprises treating soiled articles with an aqueous liquid having dissolved or dispensed therein an effective amount of the machine diswashing or rinsing composition. A conventional effective amount of the machine dishwashing composition means from 8-60 g of product dissolved or dispersed in a wash volume from 3-10 liters. According to a manual dishwashing method, soiled dishes are contacted with an effective amount of the diswashing composition, typically from 0.5-20 g (per 25 dishes being treated). Preferred manual dishwashing methods include the application of a concentrated solution to the surfaces of the dishes or the soaking in large volume of dilute solution of the detergent composition. A conventional hard surface method comprises treating soiled hard items with e.g. a sponge, brush, clothe, etc. with an aqueous liquid having dissolved or dispensed therein an effective amount of the hard surface cleaner and/or with such composition undiluted. It also encompasses or the soaking in a concentrated solution or in a large volume of dilute solution of the detergent composition. The process of the invention is conveniently carried out in the course of the cleaning process. The method of cleaning is preferably carried out at 5° C. to 95° C., especially between 10° C. and 60° C. The pH of the treatment solution is preferably from 7 to 12.

The following examples are meant to exemplify compositions of the present invention, but are not necessarily meant to limit or otherwise define the scope of the invention.

In the detergent compositions, the enzymes levels are expressed by pure enzyme by weight of the total composition and unless otherwise specified, the detergent ingredients are expressed by weight of the total compositions. The abbreviated component identifications therein have the following meanings:

| | |
|---|---|
| LAS: | Sodium linear C₁₁₋₁₃ alkyl benzene sulphonate. |
| TAS: | Sodium tallow alkyl sulphate. |
| OxyAS: | Sodium C₁ₓ-C_{1y} alkyl sulfate. |
| OxySAS: | Sodium C₁ₓ-C_{1y} secondary (2,3) alkyl sulfate. |
| CxyEz: | C₁ₓ-C_{1y} predominantly linear primary alcohol |
| | condensed with an average of z moles of ethylene oxide. |
| CxyEzS: | C₁ₓ-C_{1y} sodium alkyl sulfate condensed with an |
| | average of z moles of ethylene oxide. |
| CxEOy: | Cy alcohol with an average of ethoxylation of y. |
| NI 1: | Mixed ethoxylated/propoxylated fatty alcohol e.g. |
| | Plurafac LF404 being an alcohol with an average degree |
| | of ethoxylation of 3.8 and an average degree of |
| | propoxylation of 4.5. |
| NI 2: | C12-C14 alkyldimethyl amine oxide |
| QAS: | R₂.N+(CH₃)₂(C₂H₄OH) with R₂ = C₁₂-C₁₄. |
| QAS 1: | R₂.N+(CH₃)₂(C₂H₄OH) with R₂ = C₈-C₁₁. |
| SADS: | Sodium C14-22 alkyl disulphate of fromula 2-(R).C4H7- |
| | 1,4-(SO4-)2 where R = C10-18 |
| MBAS: | C12-18 mid branched alkyl sulphate surfactant with an |
| | average branching of 1.5 methyl or ethyl branching |
| | groups |
| MES: | x-Sulpho methylester of C18 fatty acid |
| APA: | C₈₋₁₀ amido propyl dimethyl amine. |
| Soap: | Sodium linear alkyl carboxylate derived from a 80/20 |
| | mixture of tallow and coconut fatty acids. |
| STS: | Sodium toluene sulphonate. |
| TFAA: | C₁₆-C₁₈ alkyl N-methyl glucamide. |
| TPKFA: | C₁₂-C₁₄ topped whole cut fatty acids. |
| DEQA: | Di-(tallow-oxy-ethyl) dimethyl ammonium chloride. |
| DEQA (2): | Di-(soft-tallowyloxyethyl) hydroxyethyl methyl ammonium |
| | methylsulfate. |
| SDASA: | 1:2 ratio of stearyldimethyl amine:triple-pressed stearic |
| | acid. |
| DTMAMS: | Ditallow dimethyl ammonium methylsulfate. |
| Silicate: | Amorphous Sodium Silicate (SiO₂:Na₂O ratio = 1.6- |
| | 3.2:1). |
| Metasilicate: | Sodium metasilicate (SiO₂:Na₂O ratio = 1.0). |
| Zeolite A: | Hydrated Sodium Aluminosilicate of formula |
| | Na₁₂(A1O₂SiO₂)₁₂.27H₂O having a primary particle |
| | size in the range from 0.1 to 10 micrometers (Weight |
| | expressed on an anhydrous basis). |
| SKS-6: | Crystalline layered silicate of formula δ-Na₂Si₂O₅ |
| Citrate: | Tri-sodium citrate dihydrate. |
| Citric: | Anhydrous citric acid. |
| Carbonate: | Anhydrous sodium carbonate. |
| Bicarbonate: | Sodium hydrogen carbonate. |
| Sulphate: | Anhydrous sodium sulphate. |
| Mg Sulphate: | Anhydrous magnesium sulfate. |
| STPP: | Sodium tripolyphosphate. |
| TSPP: | Tetrasodium pyrophosphate. |
| MNAA: | Random copolymer of 4:1 acrylate/maleate, average |
| | molecular weight about 70,000-80,000. |
| MA/AA 1: | Random copolymer of 6:4 acrylate/maleate, average |
| | molecular weight about 10,000. |
| AA: | Sodium polyacrylate polymer of average molecular |
| | weight 4,500. |
| Polycarboxylate: | Copolymer comprising mixture of carboxylated |
| | monomers such as acrylate, maleate and methyacrylate |
| | with a MW ranging between 2,000-80,000 such as |
| | Sokolan commercially available from BASE, being a |
| | copolymer of acrylic acid, MW 4,500. |
| Clay: | Bentonite or smectite clay. |
| PB1: | Anhydrous sodium perborate monohydrate. |
| PB4: | Sodium perborate tetrahydrate of nominal formula |
| | NaBO₃.4H₂O. |
| Percarbonate: | Anhydrous sodium percarbonate of nominal formula |
| | Na₂CO₃.3H₂O₂. |
| NaDOC: | Sodium dichloroisocyanurate. |
| TAED: | Tetraacetyl ethylene diamine. |
| NOBS: | Nonanoyloxybenzene sulfonate in the form of the sodium |
| | salt. |
| NACA-OBS: | (6-nonamidocaproyl) oxybenzene sulfonate. |
| LOBS: | Dodecanoyloxybenzene sulfonate in the form of the Na |
| | salt. |
| DOBA: | Dodecanoylbenzoic acid |
| DTPA: | Diethylene triamine pentaacetic acid. |
| HEDP: | 1,1-hydroxyethane diphosphonic acid. |
| DETPMP: | Diethyltriamine penta (methylene) phosphonate, |
| | marketed by Monsanto under the Trade name Dequest |
| | 2060. |
| EDDS: | Ethylenediamine-N,N′-disuccinic acid, (S,S) isomer in the |
| | form of its sodium salt |
| MnTACN: | Manganese 1,4,7-trimethyl-1,4,7-triazacyclononane. |
| Photoactivated: | Sulfonated zinc or alumino phtalocyanine encapsulated |
| Bleach | in dextrin soluble polymer. |
| PAAC: | Pentaamine acetate cobalt (III) salt. |
| Paraffin: | Paraffin oil sold under the tradename Winog 70 by |
| | Wintershall. |
| NaBz: | Sodium benzoate. |
| Protease: | Proteolytic enzyme sold under the tradename Savinase |
| | by Novo Nordisk A/S, the “Protease B” variant with the |
| | substitution Y217L described in EP 251 446, the |
| | “protease D” variant with the substitution set |
| | N76D/S103A/V104I and the protease described in |
| | WO99/20727, WO99/20726 and WO99/20723 with the |
| | amino acid substitution set |
| | 101G/103A/1041/159D/232V/236H/245R/248D/252K. |
| Amylase: | Amylolytic enzyme sold under the tradename Termamyl ® |
| | and Duramyl ® available from Novo Nordisk A/S and |
| | those variants having improved thermal stability with |
| | amino acid deletions P181* + G182* or Ti 83* + G184* as |
| | described in WO95/35382. |
| Lipase: | Lipolytic enzyme sold under the tradename Lipolase, |
| | Lipolase Ultra by Novo Nordisk A/S and Lipomax by Gist- |
| | Brocades. |
| MaltoH: | Maltogenic alpha-amylase sold under the tradename |
| | Novamyl by Novo Nordisk A/S |
| AMG: | Amyloglucosidase sold under the tradename AMG from |
| | Novo Nordisk A/S. |
| Cellulase: | Cellulytic enzyme sold under the tradename Carezyme, |
| | Celluzyme and/or Endolase by Novo Nordisk A/S. |
| CMC: | Sodium carboxymethyl cellulose. |
| PVP: | Polyvinyl polymer, with an average molecular weight of |
| | 60,000. |
| PVNO: | Polyvinylpyridine-N-Oxide, with an average molecular |
| | weight of 50,000. |
| PVPVI: | Copolymer of vinylimidazole and vinylpyrrolidone, with an |
| | average molecular weight of 20,000. |
| Brightener 1: | Disodium 4,4′-bis(2-sulphostyryl)biphenyl. |
| Brightener 2: | Disodium 4,4′-bis(4-anilino-6-morpholino-1,3,5-triazin-2- |
| | yl)stilbene-2:2′-disulfonate. |
| Brightener 3: | Disodium 4,4′bis(4,6-dianilino-1,3,5-triazin-2-yl)amino |
| | stilbene-2-2′-disulfonate. |
| Silicone antifoam: | Polydimethylsiloxane foam controller with siloxane- |
| | oxyalkylene copolymer as dispersing agent with a ratio of |
| | said foam controller to said dispersing agent of 10:1 to |
| | 100:1. |
| Suds Suppressor: | 12% Silicone/silica, 18% stearyl alcohol,70% starch in |
| | granular form. |
| Thickener: | High molecular weight crosslinked polyacrylates such as |
| | Carbopol offered by B.F. Goodrich Chemical Company |
| | and Polygel. |
| SRP 1: | Anionically end capped poly esters. |
| SRP 2: | Soil Release Polymer selected from 1) Non-cotton soil |
| | release polymer according to U.S. Pat. No. 5,415,807, |
| | Gosselink, Pan, Kellett and Hall, issued May 16, 1995 or |
| | and/or from 2) Non-cotton soil release polymer according |
| | to US application no. 60/051517. |
| QEA: | bis((C₂H₅O)(C₂H₄O)ₙ)(CH₃) —N⁺-C₆H₁₂—N⁺-(CH₃) |
| | bis((C₂H₅O)(C₂H₄O))ₙ, wherein n = from 20 to 30. |
| PEI: | Polyethyleneimine with an average molecular weight of |
| | between 600-1800 and an average ethoxylation degree |
| | of 7-20 ethyleneoxy residues per nitrogen. |
| SCS: | Sodium cumene sulphonate. |
| HMWPEO: | High molecular weight polyethylene oxide. |
| PEG X: | Polyethylene glycol, of a molecular weight of X |
| PEO: | Polyethylene oxide, with an average molecular weight of |
| | 5,000. |
| TEPAE: | Tetreaethylenepentaamine ethoxylate. |
| BTA: | Benzotriazole. |
| PH: | Measured as a 1% solution in distilled water at 20° C. |

### EXAMPLE 1

The following granular laundry detergent compositions were prepared according to the present invention:

| | I | II | III | IV | V |
|---|---|---|---|---|---|
| Spray-dried Granules | | | | | |
| LAS | 10.0 | 10.0 | 15.0 | 5.0 | 5.0 |
| TAS | — | 1.0 | — | — | — |
| MBAS | — | — | — | 5.0 | 5.0 |
| C₄₅AS | — | — | 1.0 | — | 2.0 |
| C₄₅AE₃S | — | — | — | 1.0 | — |
| QAS | — | — | 1.0 | 1.0 | — |
| DTPA, HEDP and/or EDDS | 0.3 | 0.3 | 0.5 | 0.3 | — |
| Mg Sulfate | 0.5 | 0.5 | 0.1 | — | |
| Citrate | — | — | — | 3.0 | 5.0 |
| Carbonate | 10.0 | 7.0 | 15.0 | — | — |
| Sulphate | 5.0 | 5.0 | — | — | 5.0 |
| Silicate | — | — | — | — | 2.0 |
| Zeolite A | 16.0 | 18.0 | 20.0 | 20.0 | — |
| SKS-6 | — | — | — | 3.0 | 5.0 |
| MA/AA or AA | 1.0 | 2.0 | 11.0 | — | — |
| PEG 4000 | — | 2.0 | 0.1 | — | 3.0- |
| QEA | 1.0 | — | — | — | 1.0 |
| Brightener 1 or 2 or 3 | 0.05 | 0.05 | 0.05 | — | 0.05 |
| Silicone oil | 0.01 | 0.01 | 0.01 | — | — |
| Agglomerate | | | | | |
| Carbonate | — | — | — | — | 4.0 |
| SKS-6 | 6.0 | — | — | — | 6.0 |
| LAS | 4.0 | 5.0 | — | — | 5.0 |
| Dry-add particulate components | | | | | |
| Maleic acid/carbonate/bicarbonate | 8.0 | 10.0 | 10.0 | 4.0 | — |
| (40:20:40) | | | | | |
| QEA | — | — | — | 0.2 | 0.5 |
| NACA-OBS | 3.0 | — | — | 4.5 | — |
| NOBS | 1.0 | 3.0 | 3.0 | — | — |
| TAED | 2.5 | — | — | 1.5 | 2.5 |
| MBAS | — | — | — | 8.0 | — |
| LAS (flake) | 10.0 | 10.0 | — | — | — |
| Spray-on | | | | | |
| Brightener 1 or 2 or 3 | 0.2 | 0.2 | 0.3 | 0.1 | 0.2 |
| Perfume | 1.0 | 0.5 | 1.1 | 0.8 | 0.3 |
| Dry-add | | | | | |
| Citrate | — | — | 20.0 | 4.0 | — |
| Percarbonate | 15.0 | 3.0 | 6.0 | 10.0 | — |
| Perborate | — | — | — | — | 6.0 |
| Photoactivated bleach | 0.02 | 0.02 | 0.02 | 0.1 | 0.05 |
| Enzymes (cellulase, amylase, | 0.04 | 0.01 | 0.02 | 0.02 | 0.05 |
| protease and/or lipase) | | | | | |
| MaltoH | 1.0 | 0.05 | 0.002 | 0.001 | 0.05 |
| Carbonate | 0.0 | 10.0 | — | — | — |
| Perfume (encapsulated) | — | 0.5 | 0.5 | — | 0.3 |
| Suds suppressor | 1.0 | 0.6 | 0.3 | — | 0.10 |
| Soap | 0.5 | 0.2 | 0.3 | 3.0 | 0.5 |
| Citric | — | — | — | 6.0 | 6.0 |
| SKS-6 | — | — | — | 4.0 | — |

Fillers up to 100%

### EXAMPLE 2

The following granular laundry detergent compositions were prepared according to the present invention:

| | I | II | III | IV |
|---|---|---|---|---|
| Blown powder | | | | |
| MES | 2.0 | 0.5 | 1.0 | — |
| SADS | — | — | — | 2.0 |
| LAS | 6.0 | 5.0 | 11.0 | 6.0 |
| TAS | 2.0 | — | — | 2.0 |
| Zeolite A | 24.0 | — | — | 20.0 |
| STPP | — | 27.0 | 24.0 | — |
| Sulfate | 4.0 | 6.0 | 13.0 | — |
| MA/AA | 1.0 | 4.0 | 6.0 | 2.0 |
| Silicate | 1.0 | 7.0 | 3.0 | 3.0 |
| CMC | 1.0 | 1.0 | 0.5 | 0.6 |
| Brightener 1 | 0.2 | 0.2 | 0.2 | 0.2 |
| Silicone antifoam | 1.0 | 1.0 | 1.0 | 0.3 |
| DTPMP | 0.4 | 0.4 | 0.2 | 0.4 |
| Spray on | | | | |
| Brightener 1 or 2 or 3 | 0.02 | — | — | 0.02 |
| C45E7 | — | — | 0.05 | 5.0 |
| C45E2 | 2.5 | — | | — |
| C45E3 | 2.6 | — | 0.05 | — |
| Perfume | 0.5 | 0.3 | 0.5 | 0.2 |
| Silicone antifoam | 0.3 | 0.3 | 0.3 | — |
| Dry additives | | | | |
| QEA | — | — | — | 1.0 |
| EDDS | 0.3 | — | — | — |
| Sulfate | 2.0 | 3.0 | 5.0 | 10.0 |
| Carbonate | 6.0 | 13.0 | 15.0 | 14.0 |
| Citric | 2.5 | — | — | 2.0 |
| QAS | 0.5 | — | — | 0.5 |
| SKS-6 | 10.0 | — | — | — |
| Percarbonate | 4.0 | 3.0 | — | 1.9 |
| PB4 | | | | |
| NOBS | 0.5 | — | — | — |
| TAED | 0.75 | 4.5 | — | — |
| Clay | — | — | 10.0 | — |
| Protease | 0.03 | — | 0.03 | — |
| Lipase | 0.008 | 0.008 | 0.008 | 0.004 |
| MaltoH | 0.001 | 0.01 | 0.01 | 0.004 |
| Amylase | 0.003 | — | 0.003 | 0.006 |
| Brightener 1 | 0.05 | — | — | 0.05 |

| | |
|---|---|
| Misc/minor and speckles | up to 100% |

### EXAMPLE 3

The following granular laundry detergent compositions were prepared according to the invention:

| | I | II | III | IV | V | VI |
|---|---|---|---|---|---|---|
| Blown powder | | | | | | |
| LAS | 23.0 | 8.0 | 7.0 | 9.0 | 7.0 | 7.0 |
| QAS | — | — | — | — | 1.0 | — |
| C45AS | 6.0 | 6.0 | 5.0 | 8.0 | — | — |
| C45AE11S | — | 1.0 | 1.0 | 1.0 | — | — |
| MES | 2.0 | — | — | — | 2.0 | 4.0 |
| Zeolite A | 10.0 | 18.0 | 14.0 | 12.0 | 10.0 | 10.0 |
| MA/AA | — | 0.5 | — | — | — | 2.0 |
| MA/AA 1 | 7.0 | — | — | — | — | — |
| AA | — | 3.0 | 3.0 | 2.0 | 3.0 | 3.0 |
| Sulfate | 5.0 | 6.3 | 11.1 | 11.0 | 11.0 | 18.1 |
| Silicate | 10.0 | 1.0 | 1.0 | 1.0 | 1.0 | 1.0 |
| Carbonate | 15.0 | 20.0 | 10.0 | 20.7 | 8.0 | 6.0 |
| PEG4000 | 0.4 | 1.5 | 1.5 | 1.0 | 1.0 | 1.0 |
| DTPA | — | 0.9 | 0.5 | — | — | 0.5 |
| Brightener 2 | 0.3 | 0.2 | 0.3 | — | 0.1 | 0.3 |
| Spray on | | | | | | |
| 045E7 | — | — | 0.5 | — | — | 2.0 |
| C25E9 | 0.5 | — | — | — | — | — |
| C23E9 | — | — | 2.0 | — | 2.0 | |
| Perfume | 0.3 | 0.3 | 0.3 | 2.0 | 0.3 | 0.3 |
| Agglomerates | | | | | | |
| C45AS | — | 5.0 | 5.0 | 2.0 | — | 5.0 |
| LAS | — | 2.0 | 2.0 | — | — | 2.0 |
| Zeolite A | — | 7.5 | 7.5 | 8.0 | — | 7.5 |
| Carbonate | — | 4.0 | 4.0 | 5.0 | — | 4.0 |
| PEG 4000 | — | — | 0.5 | — | — | 0.5 |
| Misc (water | — | 2.0 | 2.0 | 2.0 | — | 2.0 |
| etc) | | | | | | |
| Dry additives | | | | | | |
| QASI | — | — | — | — | 1.0 | — |
| Citric | — | — | — | — | 2.0 | — |
| PB4 | — | — | — | — | 5 | — |
| PB1 | — | — | 4 | 1.0 | — | — |
| Percarbonate | 2.0 | — | — | 1.0 | — | — |
| Carbonate | — | 5.3 | 1.8 | — | 4.0 | 4.0 |
| NOBS | 0.5 | — | 0.4 | 0.3 | — | — |
| Clay | — | — | — | — | — | 10.0 |
| TAED | 0.6 | — | 0.6 | 0.3 | 0.9 | — |
| Methyl | 0.2 | — | — | — | — | 0.5 |
| cellulose | | | | | | |
| DTPA | 0.7 | 0.5 | 1.0 | 0.5 | 0.5 | 1.2 |
| speckle | — | — | — | 0.2. | 0.5 | — |
| SKS-6 | 8.0 | — | — | — | — | — |
| STS | — | — | 2.0 | — | 1.0 | — |
| Cumene | — | 1.0 | — | — | — | 2.0 |
| sulfonic | | | | | | |
| acid | | | | | | |
| Lipase | 0.004 | — | 0.004 | — | 0.004 | 0.008 |
| Cellulase | 0.0005 | 0.0005 | 0.0005 | 0.0007 | 0.0005 | 0.0005 |
| Amylase | 0.003 | — | 0.001 | — | 0.003 | — |
| MaltoH | 0.01 | 5.0 | 0.05 | 0.002 | 0.001 | 0.05 |
| AMG | — | — | 0.001 | 0.001 | — | — |
| Protease | 0.01 | 0.015 | 0.015 | 0.009 | — | — |
| PVPVI | — | — | — | — | 0.5 | 0.1 |
| PVP | — | — | — | — | 0.5 | — |
| PVNO | — | — | 0.5 | 0.3 | — | — |
| QEA | — | — | — | — | 1.0 | — |
| SRP1 | 0.2 | 0.5 | 0.3 | — | 0.2 | — |
| Silicone | 0.2 | 0.4 | 0.2 | 0.4 | 0.1 | — |
| antifoam | | | | | | |
| Mg sulfate | — | — | 0.2 | — | 0.2 | — |

Misc/minors up to 100%

### EXAMPLE 4

The following granular laundry detergent compositions were prepared according to the present invention:

| | I | II | III | IV |
|---|---|---|---|---|
| Base granule | | | | |
| STPP | — | 22.0 | — | 15.0 |
| Zeolite A | 30.0 | — | 24.0 | 5.0 |
| Sulfate | 5.5 | 5.0 | 7.0 | 7.0 |
| MA/AA | 3.0 | — | — | — |
| AA | — | 1.6 | 2.0 | — |
| MA/AA 1 | — | 12.0 | — | 6.0 |
| LAS | 14.0 | 10.0 | 9.0 | 20.0 |
| C45A5 | 8.0 | 7.0 | 9.0 | 7.0 |
| C45AE11S | — | 1.0 | — | 1.0 |
| MES | 0.5 | 4.0 | 6.0 | — |
| SADS | 2.5 | — | — | 1.0 |
| Silicate | — | 1.0 | 0.5 | 10.0 |
| Soap | 2.0 | — | — | |
| Brightener 1 | 0.2 | 0.2 | 0.2 | 0.2 |
| Carbonate | 6.0 | 9.0 | 8.0 | 10.0 |
| PEG 4000 | — | 1.0 | 1.5 | — |
| DTPA | — | 0.4 | — | — |
| Spray on | | | | |
| C25E9 | — | — | — | 0.5 |
| C45E7 | 10 | 1.0 | — | — |
| C23E9 | — | 1.0 | 2.5 | — |
| Perfume | 0.2 | 0.3 | 0.3 | — |
| Dry additives | | | | |
| Carbonate | 5.0 | 10.0 | 13.0 | 8.0 |
| PVPVI/PVNO | 0.5 | — | 0.3 | — |
| Protease | 0.03 | 0.03 | 0.03 | 0.015 |
| Lipase | 0.008 | — | — | 0.008 |
| MaltoH | 0.01 | 3.0 | 0.05 | 0.005 |
| Amylase | 0.002 | — | — | 0.002 |
| Cellulase | 0.0002 | 0.0005 | 0.0005 | 0.0003 |
| DTPA | 0.5 | 0.3 | 0.5 | 1.0 |
| LOBS | — | 0.8 | — | 0.3 |
| PB1 | 5 | 3.0 | 10 | 4.0 |
| DOBA | 1.0 | — | 0.4 | — |
| TAED | 0.5 | 0.3 | 0.5 | 0.6 |
| Sulfate | 4.0 | 5.0 | — | 5.0 |
| SRP1 | — | 0.4 | — | — |
| Suds supressor | — | 0.5 | — | — |
| speckle | 09 | — | 2.7 | 1.2 |

Misc/minor to 100%

### EXAMPLE 5

The following granular laundry detergent compositions were prepared according to the present invention:

| | I | II | III | IV | IV | V | VI |
|---|---|---|---|---|---|---|---|
| C₁₃ LAS | 3 | 16.0 | 23.0 | 19.0 | 18.0 | 20.0 | 16.0 |
| C₄₅ AS | | 4.5 | — | | — | — | 4.0 |
| C₄₅AE (3)S | — | — | 2.0 | — | 1.0 | 1.0 | 1.0 |
| C₄₅ AE (3.0) | 12.0 | 2.0 | — | 1.3 | — | — | 0.6 |
| C₉-C₁₄ alkyl | | | — | — | 1.0 | 0.5 | 2.0 |
| dimethyl hydroxy | | | | | | | |
| ethyl quaternary | | | | | | | |
| ammonium salt | | | | | | | |
| Tallow fatty acid | — | — | — | — | — | — | 1.0 |
| STPP | 23.0 | 25.0 | 24.0 | 22,0 | 20.0 | 15.0 | 20.0 |
| Carbonate | 15.0 | 12.0 | 15.0 | 10.0 | 13.0 | 11.0 | 10.0 |
| AA | 0.5 | 0.5 | 0.5 | 0.5 | — | — | — |
| MA/AA | — | — | 1.0 | 1.0 | 1.0 | 2.0 | 0.5 |
| Silicate | 3.0 | 6.0 | 9.0 | 8.0 | 9.0 | 6.0 | 8.0 |
| Sulfate | 25.0 | 18.0 | 20.0 | 18.0 | 20.0 | 22.0 | 13.0 |
| Sodium perborate | 5.0 | 5.0 | 10.0 | 8.0 | 3.0 | 1.0 | 2.0 |
| PEG 4000 | 1.5 | 1.5 | 1.0 | 1.0 | — | — | 0.5 |
| CMC | 1.0 | 1.0 | 1.0 | — | 0.5 | 0.5 | 0.5 |
| Citric | — | — | — | — | — | — | — |
| NOBS/DOBS | 0.5 | 1.0 | 0.5 | 0.5 | 1.0 | 0.7 | 0.3 |
| TAED | 1.5 | 1.0 | 2.5 | 3.0 | 0.3 | 0.2 | 0.5 |
| SRP 2 | 1.5 | 1.5 | 1.0 | 1.0 | 1.0 | 1.0 | 1.0 |
| Moisture | 7.5 | 7.5 | 6.0 | 7.0 | 5.0 | 3.0 | 5.0 |
| Mg | — | — | — | — | 1.0 | 0.5 | 1.5 |
| DTPA, HEDP | — | — | — | — | 0.8 | 0.6 | 1.0 |
| and/or EDDS | | | | | | | |
| MaltoH | 0.01 | 0.01 | .005 | 0.05 | 1.0 | 1.0 | .001 |
| Enzymes | — | — | — | — | 0.05 | 0.04 | 0.05 |
| (amylase, | | | | | | | |
| cellulase and/or | | | | | | | |
| protease) | | | | | | | |

| | |
|---|---|
| Minors, e.g. | Up to 100% |
| perfume, | |
| Brightener, | |
| photo-bleach, | |
| speckles | |

### EXAMPLE 6

The following granular laundry detergent compositions were prepared according to the present invention:

| | I | II | III | IV |
|---|---|---|---|---|
| C₁₃ LAS | | | | |
| C₄₅ AS | 39 | 40 | 45 | — |
| C₄₅ AE (0.5)5 | 2.0 | 2.0 | — | — |
| C₄₅ AE (6.5) | 0.5 | 0.5 | 0.5 | 5.0 |
| C₉-C₁₄ alkyl dimethyl | 1.0 | — | — | 0.5 |
| hydroxy ethyl | | | | |
| quaternary ammonium | | | | |
| salt | | | | |
| Tallow fatty acid | 0.5 | — | — | — |
| Tallow alcohol | — | — | 1.0 | 0.3 |
| ethoxylate (50) | | | | |
| STPP | — | 41.0 | — | 20.0 |
| Zeolite A | 26.3 | — | 21.3 | 1.0 |
| Carbonate | 23.9 | 12.4 | 25.2 | 17.0 |
| AA | 3.4 | 0.0 | 2.7 | — |
| MA/AA | — | — | 1.0 | 1.5 |
| Silicate | 2.4 | 6.4 | 2.1 | 6.0 |
| Sulfate | 10.5 | 10.9 | 8.2 | 15.0 |
| Sodium perborate | 1.0 | 1.0 | 1.0 | 2.0 |
| PEG 4000 | 1.7 | 0.4 | 1.0 | — |
| CMC | 1.0 | — | — | 0.3 |
| Citric | — | — | 3.0 | — |
| NOBS/DOBS | 0.2 | 0.5 | 0.5 | 0.1 |
| TAED | 0.6 | 0.5 | 0.4 | 0.3 |
| SRP2 | 1.5 | 1.5 | 1.0 | 1.0 |
| Moisture | 7.5 | 3.1 | 6.1 | 7.3 |
| Mg sulphate | — | — | — | 1.0 |
| DTPA, HEDP and/or | — | — | — | 0.5 |
| EDDS | | | | |
| Enzymes (amylase, | — | 0.025 | — | 0.04 |
| cellulase, protease | | | | |
| and/or lipase) | | | | |
| MaltoH | 0.02 | 0.05 | 0.005 | 0.008 |

| | |
|---|---|
| Misc/Minors including | Up to 100% |
| perfume, brightener, | |
| photo-bleach | |

### EXAMPLE 7

The following laundry detergent compositions in the form of a tablet or granular formulation were prepared according to the present invention:

| | I | II | III | IV | V | VI |
|---|---|---|---|---|---|---|
| C₁₃ LAS | 20.0 | 16.0 | 8.5 | 5 | 20.0 | 6.0 |
| C₄₅ AS | — | 4.0 | | — | — | — |
| C₄₅ AE(3)S | 1.0 | 1.0 | — | — | — | — |
| C₄₅ AE | — | 5.0 | 5.5 | 4.0 | — | 0.5 |
| C₉-C₁₄ alkyl | 0.5 | 2.0 | — | — | — | — |
| dimethyl | | | | | | |
| hydroxy | | | | | | |
| ethyl | | | | | | |
| quaternary | | | | | | |
| ammonium | | | | | | |
| salt | | | | | | |
| Tallow fatty | — | 1.0 | — | — | — | — |
| acid | | | | | | |
| STPP/Zeolite | 10.0 | 20.0 | 30.0 | 20.0 | 25.0 | 25.0 |
| Carbonate | 41.0 | 30.0 | 30.0 | 25.0 | 45.0 | 24.0 |
| AA | | | | | | |
| MA/AA | 2.0 | 0.5 | 0.5 | 1.0 | — | — |
| Silicate | 6.0 | 8.0 | 5.0 | 6.0 | 8.0 | 5.0 |
| Sulfate | 2.0 | 3.0 | — | — | — | 8.0 |
| Sodium | 1.0 | — | 20.0 | 14.0 | — | — |
| perborate/ | | | | | | |
| percarbonate | | | | | | |
| PEG 4000 | — | 0.5 | — | — | — | 0.5 |
| CMC | 0.5 | 0.5 | 0.5 | 0.5 | — | 0.5 |
| Citric | | | | | | |
| NOBS/DOBS | 0.7 | — | — | — | — | — |
| TAED/ | 0.7 | — | — | 5.0 | 4.5- | — |
| Preformed | | | | | | |
| per acid | | | | | | |
| DTPA, HEDP | — | — | 0.5 | 0.5 | — | |
| and/or EDDS | | | | | | |
| SRP | 1.0 | — | 1.0 | 1.0 | — | — |
| Clay | 4.0 | 3.0 | 7.0 | 10.0 | 6.0 | 8.0 |
| PEO | 1.0 | 0.5 | 2.0 | 0.5 | 1.0 | 0.5 |
| Humectant | 0.5 | — | — | 0.5 | — | — |
| wax | 0.5 | — | — | 0.5 | — | — |
| Cellulose | 2.0 | — | — | 1.5 | — | 1.0 |
| Sodium acetate | — | — | 1.0 | 0.5 | 4.0 | 1.0 |
| Moisture | 3.0 | 5.0 | 5.0 | 5.0 | 8.0 | 10.0 |
| Mg sulphate | 0.5 | 1.5 | — | — | — | — |
| Soap/suds | 0.6 | 1.0 | 1.0 | 0.8 | 0.5 | — |
| suppressor | | | | | | |
| Enzymes | 0.04 | 0.04 | 0.01 | 0.02 | 0.02 | 0.03 |
| (amylase, | | | | | | |
| cellulase, | | | | | | |
| protease | | | | | | |
| and/or lipase) | | | | | | |
| MaltoH | 0.03 | 0.01 | 0.05 | .003 | 0.1 | .005 |

| | |
|---|---|
| Minors, e.g. | Up to 100% |
| perfume, | |
| PVP, | |
| PVPVI/PVNO, | |
| brightener, | |
| photo-bleach, | |
| speckles, . . . | |

### EXAMPLE 8

The following laundry detergent compositions were prepared according to the present invention

| | I | II | III | IV | V |
|---|---|---|---|---|---|
| C₁₃ LAS | 5.0 | 16.9 | 23.0 | 19.0 | 18.0 |
| C₄₅ AS | — | 45 | — | — | — |
| C₄₅ AE(3)S | — | — | 2.0 | — | 1.0 |
| C₄₅ AE | 10 | 2.0 | — | 1.3 | — |
| C₉-C₁₄ alkyl dimethyl hydroxy | — | — | — | — | 1.0 |
| ethyl quaternary ammonium | | | | | |
| salt | | | | | |
| STPP/Zeolite | 23.0 | 25.0 | 14.0 | 22,0 | 20.0 |
| Carbonate | 25.0 | 22.0 | 35.0 | 20.0 | 28.0 |
| AA | 0.5 | 0.5 | 0.5 | 0.5 | — |
| MA/AA | — | — | 1.0 | 1.0 | 1.0 |
| Silicate | 3.0 | 6.0 | 9.0 | 8.0 | 9.0 |
| Sodium perborate/ | 5.0 | 5.0 | 10.0 | — | 3.0 |
| percarbonate | | | | | |
| PEG 4000 | 1.5 | 1.5 | 1.0 | 1.0 | — |
| CMC | 1.0 | 1.0 | 1.0 | — | 0.5 |
| NOBS/DOBS | — | 1.0 | — | — | 1.0 |
| TAED/Preformed per acid | 1.5 | 1.0 | 2.5 | — | 3.0 |
| DTPA, HEDP and/or EDDS | 0.5 | 0.5 | 0.5 | — | 1.0 |
| SRP | 1.5 | 1.5 | 1.0 | 1.0 | — |
| Clay | 5.0 | 6.0 | 12.0 | 7.0 | 10.0 |
| Flocculating agent PEO | 0.2 | 0.2 | 3.0 | 2.0 | 0.1 |
| Humectant | — | — | — | — | 0.5 |
| wax | 0.5 | — | — | — | — |
| Cellulose | 0.5 | 2.0 | — | — | 3.0 |
| Sodium acetate | 2.0 | 1.0 | 3.0 | — | — |
| Moisture | 7.5 | 7.5 | 6.0 | 7.0 | 5.0 |
| Soap/suds suppressor | — | — | 0.5 | 0.5 | 0.8 |
| MaltoH | 0.02 | 0.02 | .005 | .005 | 0.01 |
| Enzymes (amylase, cellulase, | — | — | — | — | 0.045 |
| protease and/or lipase) | | | | | |

| | |
|---|---|
| Misc/Minors, e.g. perfume, | Up to 100% |
| PVP, PVPVI/PVNO, | |
| speckles, | |
| brightener, | |
| photo-bleach, . . . | |

### EXAMPLE 9

The following liquid laundry detergent compositions were prepared according to the present invention:

| | I | II | III | IV | V | VI |
|---|---|---|---|---|---|---|
| LAS | — | — | — | 1.0 | 2.0 | — |
| C25AS | 16.0 | 13.0 | 14.0 | 5.0 | — | 6.5 |
| C25AE3S | 5.0 | 1.0 | — | 10.0 | 19.0 | 3.0 |
| C25E7 | 2.0 | 3.5 | 0.05- | 2.5 | 2.0 | — |
| NI 2 | 0.5 | 1.0 | 0.03 | 2.0 | — | — |
| TFAA | 5.0 | 4.5 | 4.5 | 6.5 | 4.0 | — |
| APA | 2.0 | 1.0 | — | 3.0 | — | 0.5 |
| QAS | — | — | 2.0 | — | 1.5 | — |
| TPKFA | 4.5 | 8.0 | 15.0 | — | 5.0 | 5.0 |
| Citric | 2.2 | 3.0 | — | 0.5 | 1.0 | 2.0 |
| Rapeseed fatty | 2.0 | — | — | 3.0 | 6.0 | 1.5 |
| acid | | | | | | |
| Ethanol | 3.2 | 2.0 | 2.5 | 2.2 | — | 0.5 |
| 1,2 Propandiol | 5.7 | 8.5 | 6.5 | 7.0 | 7.0 | 5.5 |
| Mono- | 5.0 | 7.5 | — | 5.0 | 1.0 | 2.0 |
| ethanolamine | | | | | | |
| TEPAE | — | 1.2 | — | 0.5 | 0.5 | — |
| PEI2 | — | 1.5 | — | 1.0 | 0.8 | — |
| DTPMP | 1.3 | 0.5 | 0.8 | 0.5 | — | 0.2 |
| HEDP | — | 0.5 | 0.2 | 1.0 | — | — |
| Protease | 0.02 | — | 0.02 | 0.02 | 0.02 | 0.01 |
| MaltoH | 0.01 | 0.02 | 0.005 | 0.01 | 0.005 | 0.002 |
| AMG | 0.001 | — | — | — | — | 0.001 |
| Lipase | 0.002 | 0.001 | 0.001 | — | 0.001 | — |
| Amylase | .0008 | .0006 | .0006 | 0.002 | 0.001 | 0.001 |
| Cellulase | 0.002 | 0.002 | — | 0.002 | 0.001 | — |
| SRP1 | 0.20 | 0.15 | 0.10 | — | 0.17 | 0.04 |
| PVNO | — | — | — | 0.05 | 0.10 | — |
| Brightener 3 | 0.20 | 0.15 | 0.10 | 0.05 | — | 0.05 |
| Suds | 0.25 | 0.20 | 0.15 | 0.15 | 0.30 | 0.10 |
| Suppressor | | | | | | |
| Calcium | 0.02 | 0.02 | — | 0.01 | 0.01 | — |
| Chloride | | | | | | |
| Boric acid | 2.5 | 2.0 | 1.5 | 2.2 | 1.5 | 1.2 |
| Bentonite Clay | — | — | 5.5 | — | — | — |
| NaOH to pH | 8.0 | 7.5 | 7.7 | 8.0 | 7.0 | 7.5 |

Water/minors to 100%

### EXAMPLE 10

The following non-aqueous liquid detergent compositions were prepared in accordance with the present invention:

| | I | II | III |
|---|---|---|---|
| LAS | 16.0 | 16.0 | 16.0 |
| C23 E05S | 21.5 | 21.5 | 19.0 |
| Butoxy Propoxy Propanol | 18.5 | — | 16.0 |
| NI2 | 0.05 | 1.0 | 2.0 |
| Hexylene Glycol | — | 18.5 | 5.0 |
| Sodium citrate dihydrate | 6.8 | 6.8 | 3.8 |
| [NACA-OBS] Na salt | 6.0 | 6.0 | 6.0 |
| Methyl sulfate salt of methyl quaternized | 1.3 | 1 .3 | 1.3 |
| polyethoxylated hexamethylene diamine | | | |
| EDDS | 1.2 | 1.2 | 1.2 |
| MNAA | — | — | 3.0 |
| Sodium Carbonate | 10.0 | 10.0 | 10.0 |
| Protease | 0.05 | — | 0.02 |
| MaltoH | 1.0 | 0.01 | 0.02 |
| Amylase | 0.01 | 0.01 | 0.01 |
| Cellulase | 0.0001 | 0.0001 | 0.0001 |
| PB1 | 12.0 | 12.0 | 12.0 |
| Silicone antifoam | 0.75 | 0.75 | 1.1 |
| Perfume | 1.7 | 1.7 | 1.7 |
| Titanium Dioxide | 0.5 | 0.5 | 0.5 |
| Dichloro -5,12-Dimethyl-1,5,8,12- | — | 0.03 | 0.03 |
| tetraazabicyclo [6.6.2] hexadecane | | | |
| Manganese (II) | | | |
| Brightener 2 | 0.2 | 0.2 | 0.2 |
| Sodium hydrogenated C16-18 fatty soap | 1 | 1 0.5 | |
| Coloured Speckles | 0.4 | 0.4 | 0.4 |
| Miscellaneous up to 100% | | | |

### EXAMPLE 11

The following laundry detergent compositions in the form of a tablet were prepared according to the present invention

i) a detergent base powder of composition I was prepared as follows: all the particulate material of base composition I were mixed together in a mixing drum to form a homogenous particulate mixture. During this mixing, the spray-ons were carried out.

ii) Tablets were then made the following way: 50 g of the matrix was introduced into a mould of circular shape with a diameter of 5.5 cm, and compressed to give a tablet tensile strength (or diametrical fracture stress) of 10 kPa.

iii) The tablets were then dipped in a bath comprising 90 parts of sebacic acid and 10 parts per weight of Nymcel-ZSB16™ by Metsa Serla at 140° C. The time the tablet was dipped in the heated bath was adjusted to allow application of 4 g of the bath mixture. The tablet was then left to cool at ambient temperature of 25° C. for 24 hours. The tensile strength of the coated tablet was increased to a tensile strength of 30 kPa.

| | |
|---|---|
| Anionic agglomerates 1 (40% anionic, 27% zeolite and 33% | 21.5 |
| carbonate) | |
| Anionic agglomerates 2 (40% anionic, 28% zeolite and 32% | 13.0 |
| carbonate) | |
| Cationic agglomerates (20% cationic, 56% zeolite and 24% | 5.5 |
| sulphate) | |
| Layered silicate (95% SKS 6 and 5% silicate) | 10.8 |
| Sodium percarbonate | 14.2 |
| Bleach activator agglomerates (81% TAED, 17% acrylic/maleic | 5.5 |
| copolymer (acid form) and 2% water) | |
| Carbonate | 10.98 |
| EDDS/Sulphate particle (58% of EDDS, 23% of sulphate and | 0.5 |
| 19% water) | |
| HEDP | 0.8 |
| SRP | 0.3 |
| Fluorescer | 0.2 |
| Photoactivated bleach (Zinc phthalocyanine sulphonate 10% | 0.02 |
| active) | |
| Soap powder | 1.4 |
| Suds suppressor (11.5% silicone oil; 59% of zeolite and 29.5% | 1.9 |
| of water) | |
| Citric | 7.1 |
| MaltoH | 0.05 |
| Protease | 0.03 |
| Lipase | 0.006 |
| Cellulase | 0.0005 |
| Amylase | 0.02 |
| PEG4000 | 1.0 |
| Binder spray-on system (25% of Lutensit K-HD 96; 75% by | 4.0 |
| weight of PEG) | |

### EXAMPLE 12

The following laundry detergent compositions in the form of a tablet were prepared according to the present invention:

| | I | II | III | IV | V | VI |
|---|---|---|---|---|---|---|
| First Phase | | | | | | |
| Percarbonate | — | 45.0 | 45.0 | 45.0 | 45.0 | 45.0 |
| TAED | — | 9.7 | 9.7 | 9.7 | 9.7 | 9.7 |
| Citric acid | 10.0 | 15.0 | 20.0 | 15.0 | 15.0 | 15.0 |
| STPP | — | — | — | — | — | 6.0 |
| MA/AA | 6.0 | 6.0 | 1.0 | 5.0 | — | — |
| Silicates | — | — | — | — | 6.0 | — |
| Bicarbonate | 15.0 | 15.0 | 10.0 | 15.0 | 15.0 | 15.0 |
| Nl1 | 1.0 | 0.5 | 0.2 | 0.1 | 1.5 | 1.0 |
| Carbonate | 5.0 | — | — | — | — | — |
| Brightener 1 or 2 | 0.1 | 0.1 | 0.1 | 0.1 | 0.1 | 0.1 |
| Perfume | 0.2 | 0.2 | 0.2 | 0.2 | 0.2 | 0.2 |
| C12-16 Fatty acid | — | — | — | 1.0 | — | — |
| Protease | 0.03 | 0.03 | 0.03 | 0.03 | 0.03 | 0.03 |
| Amylase | 0.02 | 0.02 | — | 0.02 | — | — |
| Second phase | | | | | | |
| MaltoH | 0.01 | 0.02 | 0.04 | 0.01 | 0.1 | 0.5 |
| Protease | 0.04 | 0.04 | 0.04 | 0.04 | 0.04 | — |
| Amylase | 0.02 | 0.02 | — | — | — | — |
| Speckles | 0.09 | 0.09 | 0.09 | 0.09 | 0.09 | 0.09 |
| PEG 4000 | 0.33 | 0.33 | 0.33 | 0.33 | 0.33 | 0.33 |
| Citric | 1.06 | 1.06 | 1.06 | 1.06 | 1.06 | 1.06 |
| Bicarbonate | 2.87 | 2.87 | 2.87 | 2.87 | 2.87 | 2.87 |

### EXAMPLE 13

The following laundry bar detergent compositions were prepared according to the present invention (Levels are given in parts per weight, enzyme are expressed in pure enzyme):

| | I | II | III | VI | V | III | VI | V |
|---|---|---|---|---|---|---|---|---|
| LAS | — | — | 19.0 | 15.0 | 21.0 | 6.75 | 8.8 | — |
| C28AS | 30.0 | 13.5 | — | — | — | 15.75 | 11.2 | 22.5 |
| Na Laurate | 2.5 | 9.0 | — | — | — | — | — | — |
| Zeolite A | 2.0 | 1.25 | — | — | — | 1.25 | 1.25 | 1.25 |
| Carbonate | 20.0 | 3.0 | 13.0 | 8.0 | 10.0 | 15.0 | 15.0 | 10.0 |
| Ca Carbonate | 27.5 | 39.0 | 35.0 | — | — | 40.0 | — | 40.0 |
| Sulfate | 5.0 | 5.0 | 3.0 | 5.0 | 3.0 | — | — | 5.0 |
| TSPP | 5.0 | — | — | — | — | 5.0 | 2.5 | — |
| STPP | 5.0 | 15.0 | 10.0 | — | — | 7.0 | 8.0 | 10.0 |
| Bentonite clay | — | 10.0 | — | — | 5.0 | — | — | — |
| DETPMP | — | 0.7 | 0.6 | — | 0.6 | 0.7 | 0.7 | 0.7 |
| CMC | — | 1.0 | 1.0 | 1.0 | 1.0 | — | — | 1.0 |
| Talc | — | — | 10.0 | 15.0 | 10.0 | — | — | — |
| Silicate | — | — | 4.0 | 5.0 | 3.0 | — | — | — |
| PVNO | 0.02 | 0.03 | — | 0.01 | — | 0.02 | — | — |
| MA/AA | 0.4 | 1.0 | — | — | 0.2 | 0.4 | 0.5 | 0.4 |
| SRP 1 | 0.3 | 0.3 | 0.3 | 0.3 | 0.3 | 0.3 | 0.3 | 0.3 |
| Amylase | — | — | 0.01 | — | — | — | 0.002 | — |
| MaltoH | 0.01 | 0.1 | 0.02 | 0.002 | 0.5 | 0.01 | 0.01 | 0.002 |
| Protease | — | 0.004 | — | 0.003 | 0.003 | — | — | 0.003 |
| Lipase | — | 0.002 | — | 0.002 | — | — | — | — |
| Cellulase | — | .0003 | — | — | .0003 | .0002 | — | — |
| PEO | — | 0.2 | — | 0.2 | 0.3 | — | — | 0.3 |
| Perfume | 1.0 | 0.5 | 0.3 | 0.2 | 0.4 | — | — | 0.4 |
| Mg sulfate | — | — | 3.0 | 3.0 | 3.0 | — | — | — |
| NI2 | 5.0 | — | 2.0 | — | — | 0.2 | 0.1 | — |
| Brightener | 0.15 | 0.1 | 0.15 | — | — | — | — | 0.1 |
| Photoactivated | — | 15.0 | 15.0 | 15.0 | 15.0 | — | — | 15.0 |
| bleach (ppm) | | | | | | | | |

### EXAMPLE 14

The following granular fabric detergent compositions which provide “softening through the wash” capability were prepared according to the present invention

| | I | II |
|---|---|---|
| C45AS | — | 10.0 |
| LAS | 7.6 | — |
| C68AS | 1.3 | — |
| C45E7 | 4.0 | — |
| C25E3 | — | 5.0 |
| Coco-alkyl-dimethyl hydroxy- | 1.4 | 1.0 |
| ethyl ammonium chloride | | |
| Citrate | 5.0 | 3.0 |
| Na-SKS-6 | — | 11.0 |
| Zeolite A | 15.0 | 15.0 |
| MA/AA | 4.0 | 4.0 |
| DETPMP | 0.4 | 0.4 |
| PB1 | 15.0 | — |
| Percarbonate | — | 15.0 |
| TAED | 5.0 | 5.0 |
| Smectite clay | 10.0 | 10.0 |
| HMWPEO | — | 0.1 |
| Protease | 0.02 | 0.01 |
| Lipase | 0.02 | 0.01 |
| MaltoH | 0.05 | 0.02 |
| Amylase | 0.03 | 0.005 |
| Cellulase | 0.001 | — |
| Silicate | 3.0 | 5.0 |
| Carbonate | 10.0 | 10.0 |
| Suds suppressor | 1.0 | 4.0 |
| CMC | 0.2 | 0.1 |

| | |
|---|---|
| Miscellaneous and minors | Up to 100% |

### EXAMPLE 15

The following rinse added fabric softener composition was prepared according to the present invention:

| | |
|---|---|
| DEQA (2) | 20.0 |
| Cellulase | 0.001 |
| MaltoH | 0.005 |
| C45EO1-3 | 1.0 |
| HCL | 0.03 |
| Antifoam agent | 0.01 |
| Blue dye | 25 ppm |
| CaCl₂ | 0.20 |
| Perfume | 0.90 |
| Miscellaneous and water | Up to 100% |

### EXAMPLE 16

The following fabric softener and dryer added fabric conditioner compositions were prepared according to the present invention:

| | I | II | III | IV | V |
|---|---|---|---|---|---|
| DEQA | 2.6 | 19.0 | — | — | — |
| DEQA(2) | — | — | — | — | 52.0 |
| DTMAMS | — | — | — | 26.0 | — |
| SDASA | — | — | 70.0 | 42.0 | 40.2 |
| Stearic acid of IV = 0 | 0.3 | — | — | — | — |
| C45EO1-3 | 1.0 | 0.5 | 13.0 | 0.5 | 0.2 |
| HCL | 0.02 | 0.02 | — | — | — |
| Ethanol | — | — | 1.0 | — | — |
| Perfume | 0.3 | 1.0 | 0.75 | 1.0 | 1.5 |
| Glycoperse S-20 | — | — | — | — | 15.4 |
| Glycerol monostearate | — | — | — | 26.0 | — |
| Digeranyl Succinate | — | — | 0.38 | — | — |
| Silicone antifoam | 0.01 | 0.01 | — | — | — |
| Electrolyte | — | 0.1 | — | — | — |
| Amylase | — | 0.2 | — | 0.2 | 0.2 |
| MaltoH | 1.0 | 0.2 | 0.1 | 0.01 | 0.01 |
| Clay | — | — | — | 3.0 | — |
| Dye | 10 ppm | 25 ppm | 0.01 | — | — |
| Water and minors | 100% | 100% | — | — | — |

### EXAMPLE 17

The following compact high density (0.96 Kg/l) dishwashing detergent compositions were prepared according to the present invention:

| | I | II | III | IV | V | VI |
|---|---|---|---|---|---|---|
| STPP | — | 51.0 | 51.0 | — | — | 44.3 |
| Citrate | 17.0 | — | — | 50.0 | 40.2 | — |
| Carbonate | 17.5 | 14.0 | 20.0 | — | 8.0 | 33.6 |
| Bicarbonate | — | — | — | 26.0 | — | — |
| Silicate | 15.0 | 15.0 | 8.0 | — | 25.0 | 3.6 |
| Metasilicate | 2.5 | 4.5 | 4.5 | — | — | — |
| PB1 | 10.0 | 8.0 | 8.0 | — | — | — |
| PB4 | — | — | — | 10.0 | — | — |
| Percarbonate | — | — | — | — | 11.8 | 4.8 |
| Nl1 | 2.0 | — | 1.5 | 3.0 | 1.9 | 5.9 |
| TAED | 2.0 | — | — | 4.0 | — | 1.4 |
| HEDP | 1.0 | — | — | — | — | — |
| DETPMP | 0.6 | — | — | — | — | — |
| MnTACN | — | — | — | — | 0.01 | — |
| PAAC | — | 0.01 | 0.01 | — | — | — |
| Paraffin | 0.5 | 0.4 | 0.4 | 0.6 | — | — |
| Protease | 0.07 | 0.05 | 0.05 | 0.03 | — | 0.01 |
| Amylase | | 0.01 | 0.01 | | | 0.006 |
| AMG | 0.001 | — | — | — | — | 0.01 |
| MaltoH | 0.02 | 0.2 | 2.0 | 1.0 | 0.002 | 0.02 |
| Lipase | — | 0.001 | — | 0.005 | — | — |
| BTA | 0.3 | 0.2 | 0.2 | 0.3 | 0.3 | 0.3 |
| Polycarboxylate | 6.0 | — | — | — | 4.0 | 0.9 |
| Perfume | 0.2 | 0.1 | 0.1 | 0.2 | 0.2 | 0.2 |
| pH | 11.0 | 11.0 | 11.3 | 9.6 | 10.8 | 10.9 |

| | |
|---|---|
| Miscellaneous, | Up to 100% |
| sulfate and water | |

### EXAMPLE 18

The following granular dishwashing detergent compositions of bulk density 1.02 Kg/L were prepared according to the present invention:

| | I | II | III | IV | V | VI |
|---|---|---|---|---|---|---|
| STPP | 30.0 | 33.5 | 27.9 | 29.6 | 33.8 | 22.0 |
| Carbonate | 30.5 | 30.5 | 30.5 | 23.0 | 34.5 | 45.0 |
| Silicate | 7.0 | 7.5 | 12.6 | 13.3 | 3.2 | 6.2 |
| Metasilicate | — | 4.5 | — | — | — | — |
| Percarbonate | — | — | — | — | 4.0 | — |
| PB1 | 4.4 | 4.5 | 4.3 | — | — | — |
| NADCC | — | — | — | 2.0 | — | 0.9 |
| Nl 1 | 1.0 | 0.7 | — | 1.9 | 0.7 | 0.5 |
| TAED | — | — | 1.0 | 1.0 | 0.9 | |
| PAAC | — | 0.004 | — | — | — | — |
| Paraffin | 0.25 | 0.25 | — | — | — | — |
| Protease | 0.036 | 0.021 | 0.03 | — | 0.006 | — |
| Amylase | 0.03 | 0.005 | — | — | 0.005 | — |
| MaltoH | 0.2 | 0.02 | 2.0 | 2.0 | 0.02 | 0.005 |
| Lipase | 0.005 | — | 0.001 | — | — | — |
| BTA | 0.15 | 0.15 | — | — | 0.2 | — |
| Perfume | 0.2 | 0.2 | 0.05 | 0.1 | 0.2 | — |
| pH | 10.8 | 11.3 | 11.0 | 10.7 | 11.5 | 10.9 |

| | |
|---|---|
| Miscellaneous,sulfate and | Up to 100% |
| water | |

### EXAMPLE 19

The following tablet detergent compositions were prepared according to the present invention by compression of a granular dishwashing detergent composition at a pressure of 13 KN/cm² using a standard 12 head rotary press:

| | I | II | III | IV | V | VI | VII | VIII |
|---|---|---|---|---|---|---|---|---|
| STPP | — | 48.8 | 54.7 | 38.2 | — | 52.4 | 56.1 | 36.0 |
| Citrate | 20.0 | — | — | — | 35.9 | — | — | — |
| Carbonate | 20.0 | 5.0 | 14.0 | 15.4 | 8.0 | 23.0 | 20.0 | 28.0 |
| Silicate | 15.0 | 14.8 | 15.0 | 12.6 | 23.4 | 2.9 | 4.3 | 4.2 |
| Protease | 0.042 | 0.072 | 0.042 | 0.031 | 0.052 | 0.023 | 0.023 | 0.029 |
| Amylase | 0.012 | 0.012 | 0.012 | 0.007 | 0.015 | 0.003 | 0.017 | 0.002 |
| MaltoH | 0.02 | 0.01 | 0.002 | 0.5 | 0.008 | 0.002 | 1.0 | 0.02 |
| Lipase | 0.005 | — | — | — | — | — | — | — |
| PB1 | 14.3 | 7.8 | 11.7 | 12.2 | — | — | 6.7 | 8.5 |
| PB4 | — | — | — | — | 22.8 | — | 3.4 | — |
| Percarbonate | — | — | — | — | — | 10.4 | — | — |
| NI 1 | 1.5 | 2.0 | 2.0 | 2.2 | 1.0 | 4.2 | 4.0 | 6.5 |
| PAAC | — | — | 0.02 | 0.009 | — | — | — | — |
| MnTACN | — | — | — | — | 0.007 | — | — | — |
| TAED | 2.7 | 2.4 | — | — | — | 2.1 | 0.7 | 1.6 |
| HEDP | 1.0 | — | — | 0.9 | — | 0.4 | 0.2 | — |
| DETPMP | 0.7 | — | — | — | — | — | — | — |
| Paraffin | 0.4 | 0.5 | 0.5 | 0.5 | — | — | 0.5 | — |
| BTA | 0.2 | 0.3 | 0.3 | 0.3 | 0.3 | 0.3 | 0.3 | — |
| Polycarboxylate | 4.0 | — | — | — | 4.9 | 0.6 | 0.8 | — |
| PEG 4,000- | — | — | — | — | — | 2.0 | — | 2.0 |
| 30,000 | | | | | | | | |
| Glycerol | — | — | — | — | — | 0.4 | — | 0.5 |
| Perfume | — | — | — | 0.05 | 0.2 | 0.2 | 0.2 | 0.2 |
| Weight of tablet | 20 g | 25 g | 20 g | 30 g | 18 g | 20 g | 25 g | 24 g |
| pH | 10.7 | 10.6 | 10.7 | 10.7 | 10.9 | 11.2 | 11.0 | 10.8 |

| | |
|---|---|
| Miscellaneous, | Up to 100% |
| sulfate and water | |

### EXAMPLE 20

The following liquid dishwashing detergent compositions of density 1.40 Kg/L were prepared according to the present invention:

| | I | II | III | IV |
|---|---|---|---|---|
| STPP | 17.5 | 17.2 | 23.2 | 23.1 |
| Carbonate | — | 2.4 | — | — |
| Silicate | 6.1 | 24.9 | 30.7 | 22.4 |
| NaOCl | 1.1 | 1.1 | 1.1 | 1.2 |
| Thickener | 1.0 | 1.1 | 1.1 | 1.0 |
| Nl 1 | 0.1 | 0.1 | 0.06 | 0.1 |
| NaBz | 0.7 | — | — | — |
| MaltoH | 0.005 | 1.0 | 0.005 | 0.02 |
| NaOH | 1.9 | — | — | — |
| KOH | 3.6 | 3.0 | — | — |
| Perfume | 0.05 | — | — | — |
| pH | 11.7 | 10.9 | 10.8 | 11.0 |

| | |
|---|---|
| Water | up to 100% |

### EXAMPLE 21

The following dishwashing compositions in the tablet form were prepared according to the present invention (Levels are indicated in g):

| | I | II | III | IV | V | VI |
|---|---|---|---|---|---|---|
| Phase 1 | | | | | | |
| STPP | 9.6 | 9.6 | 10.4 | 9.6 | 9.6 | 11.5 |
| Silicate | 0.5 | 0.7 | 1.6 | 1.0 | 1.0 | 2.4 |
| SKS-6 | 1.5 | 1.50 | | 2.30 | 2.25 | |
| Carbonate | 2.3 | 2.7 | 3.5 | 3.6 | 4.1 | 5.2 |
| HEDP | 0.2 | 0.2 | 0.2 | 0.3 | 0.3 | 0.3 |
| PB1 | 2.4 | 2.4 | 2.4 | 3.7 | 3.7 | 3.7 |
| PAAC | 0.002 | 0.002 | 0.002 | 0.003 | 0.004 | 0.004 |
| MaltoH | 0.01 | 0.02 | 0.05 | 0.002 | 0.001 | 1.0 |
| Amylase | 0.002 | 0.001 | 0.001 | 0.004 | 0.003 | 0.003 |
| Protease | 0.002 | — | 0.002 | 0.003 | 0.003 | 0.003 |
| Nl 1 | 0.4 | 0.8 | 0.8 | 1.2 | 1.2 | 1.2 |
| PEG 6000 | 0.4 | 0.3 | 0.3 | — | 0.4 | — |
| BTA | 0.04 | 0.04 | 0.04 | — | 0.06 | 0.06 |
| Paraffin | 0.1 | 0.1 | 0.1 | 0.15 | 0.15 | 0.15 |
| Perfume | 0.02 | 0.02 | 0.02 | 0.01 | 0.01 | 0.01 |
| Sulphate | — | — | — | 0.5 | 0.05 | 2.3 |
| Phase 2 | | | | | | |
| MaltoH | 0.003 | 0.003 | 0.002 | 0.01 | 0.01 | 0.01 |
| Amylase | 0.0005 | 0.0005 | 0.0004 | 0.0005 | 0.006 | 0.0004 |
| Protease | 0.009 | 0.008 | 0.01 | 0.009 | 0.008 | 0.01 |
| Citric | 0.3 | | 0.3 | 0.3 | | 0.30 |
| Sulphamic acid | — | 0.3 | — | — | 0.3 | — |
| Bicarbonate | 1.1 | 0.4 | 0.4 | 1.1 | 0.4 | 0.4 |
| Carbonate | — | 0.5 | — | — | 0.5 | — |
| Silicate | — | — | 0.6 | — | — | 0.6 |
| CaCl₂ | — | 0.07 | — | — | 0.07 | — |
| PEG 3000 | 0.06 | 0.06 | 0.06 | 0.06 | 0.06 | 0.06 |

The multi-phase tablet compositions are prepared as follows. The detergent active composition of phase 1 is prepared by admixing the granular and liquid components and is then passed into the die of a conventional rotary press. The press includes a punch suitably shaped for forming the mould. The cross-section of the die is approximately 30×38 mm. The composition is then subjected to to a compression force of 940 kg/cm² and the punch is then elevated exposing the first phase of the tablet containing the mould in its upper surface. The detergent active composition of phase 2 is prepared in similar manner and is passed into the die. The particulate active composition is then subjected to a compression force of 170 kg/cm², the punch is elevated, and the multi-phase tablet ejected from the tablet press. The resulting tablets dissolve or disintegrate in a washing machine as described above within 12 minutes, phase 2 of the tablets dissolving within 5 minutes. The tablets provide excellent dissolution and cleaning characteristics together with good tablet integrity and strength.

### EXAMPLE 22

The following manual dishwashing compositions were prepared according to the present invention:

| | I | II | III | IV | V | VI | VII | VIII |
|---|---|---|---|---|---|---|---|---|
| C12-14E0-3S | 26.0 | 34.2 | 25.0 | 26.0 | 37.0 | 26.0 | 22.0 | 32.0 |
| C11LAS | — | — | — | — | — | — | 13.0 | — |
| C12-14 amine oxide | 2.0 | 4.9 | 2.1 | — | 5.5 | 6.5 | 1 | — |
| C12-14 betaine | 2.0 | 5.0 | 2.1 | — | — | — | — | 4.0 |
| C12-14 glucose amide | 1.5 | 1.5 | 3.1 | — | — | — | — | — |
| C9-11E8-9 | 4.5 | 1 | 4.1 | 3.0 | 1.0 | 3.0 | — | 1.0 |
| Alkyl Polyglucoside | — | — | — | — | — | — | 12.0 | 3.0 |
| C1-20 Mono Ethanol | — | — | — | — | — | — | 1.5 | — |
| Amine | | | | | | | | |
| DTPA | — | 0.1 | 0 | 0-500 | 0-500 | 0-500 | 0 | 0 |
| | | | | ppm | ppm | ppm | | |
| Succinic acid | — | — | — | — | — | 0 | — | 4.5 |
| Cumene sulphonate | — | — | 4.5 | 1 to 6 | — | 1 to 6 | — | — |
| Ca ou Na xylene | — | 5.0 | — | — | 4.0 | — | 2.5 | — |
| Sulphonate | | | | | | | | |
| Mg salts (in % Mg) | 0.5 | 0.7 | 0.5 | 0.04 | 0.6 | 0.04 | 0.3 | 0 |
| 1,3 bis (methylamino) | — | — | — | 0.5 | — | 0.5 | — | — |
| cyclohexane | | | | | | | | |
| N.N-dimethylamino | — | — | — | 0.2 | — | 0.2 | — | — |
| ethyl methacrylate | | | | | | | | |
| homopolymer | | | | | | | | |
| Citric | — | — | — | 0-3.5 | | 0-3.5 | — | — |
| Ethanol | 6-8 | 5-8 | 6-9 | 4-10 | 7.0 | 4-10 | 4.0 | 4.0 |
| Protease | — | — | — | 0.08 | — | 0-0.08 | — | — |
| MaltoH | 0.05 | .002 | .005 | 0.01 | 0.4 | 0.05 | 0.002 | 0.01 |
| Amylase | — | — | — | 0.002 | — | 0.005 | 0.04 | 0.05 |
| Carbonate | — | — | — | — | — | 2.5 | — | — |
| Poly Propylene Glycol | — | — | — | 0 to 2 | — | — | — | — |
| (MW2000-4000) | | | | | | | | |
| pH | 7-8 | 7-8 | 7-8 | 8.5-11 | 7-8 | 8.5-11 | 7 | 7 |

| | |
|---|---|
| Perfume | 0.1-0.7 |
| Balance (water and minors) | Up to 100% |

### EXAMPLE 23

The following fabric and hard surface cleaner composition was prepared according to the present invention:

| | |
|---|---|
| Sulphate | 18.5 |
| Bicarbonate | 18.6 |
| Polycarboxylate | 4.1 |
| C18 Alpha Olefin | 0.2 |
| Enzyme (lipase, protease and/or cellulase) | 0.004 |
| Amylase | 0.003 |
| MaltoH | 0.05 |
| Brigthener 2 | 0.1 |
| Nl 1 | 1.0 |
| Photoactivated bleach | 0.04 |
| Coated sodium percarbonate | 45.0 |
| TAED | 8.8 |
| Citric | 2.5 |
| Perfume | 0.1 |
| Miscellaneous and water | up to 100% |

What is claimed is:

1. A detergent composition comprising a maltogenic alpha-amylase enzyme and a detergent ingredient selected from the group consisting of a nonionic surfactant, a protease, a bleaching agent and mixtures thereof.

2. A detergent composition according to claim 1 wherein said maltogenic alpha-amylase enzyme is present at a level of from about 0.0002% to about 10% pure enzyme by weight of the total detergent composition.

3. A detergent composition according to claim 2 wherein said maltogenic alpha-amylase enzyme is present at a level of from about 0.001% to about 2% pure enzyme by weight of the total detergent composition.

4. A detergent composition according to claim 2 wherein said maltogenic alpha-amylase enzyme is present at a level of from about 0.001% to about 1% pure enzyme by weight of the total detergent composition.

5. A detergent composition according to claim 1 further comprising a starch-binding domain.

6. A detergent composition according to claim 5 wherein said starch-binding domain is present in or is added to said maltogenic alpha-amylase enzyme.

7. A detergent composition according to claim 1 wherein said nonionic surfactant is selected from the group consisting of polyethylene oxide condensates of alkyl alcohols, amide oxides, polyethylene oxide condensates of alkyl acids and mixtures thereof.

8. A detergent composition according to claim 1 wherein said bleaching agent is selected from the group consisting of [Mn (5,12-dimethyl-1,5,8,12-tetraaza-bicyclo [6.6.2]hexadecane)Cl₂]; [Mn (5,12-diethyl-1,5,8,12-tetraaza-bicyclo [6.6.2] hexadecane); the combination of percarbonate with a bleach activator selected from nonanoyloxybenzene-sulfonate, phenolsulfonate ester of N-nonanoyl-6-aminocaproic acid, tetraacetylethylenediamine and mixtures thereof.

9. A detergent composition according to claim 1 wherein the protease is selected from the protease Subtilisin 309 from Bacillius subtilis, the “Protease B” variant with the substitution Y217L described in EP 251 446, ″the “protease D” variant with the substitution set N76D/S 103A/V104I; the protease described in WO99/20727, WO99/20726 and WO99/20723 with the amino acid substitution set 101G/103A/104I/159D/232V/236H/245R/248D/252K and mixtures thereof.

10. A detergent composition according to claim 1 further comprising an enzyme selected from the group consisting of a lipase, an alpha-amylase, a cyclomaltodextrin transferase, an amyloglucosidase and mixtures thereof

11. Use of a maltogenic alpha-amylase enzyme and a detergent ingredient selected from the group consisting of a nonionic surfactant, a protease, a bleaching agent and mixtures thereof, in a detergent composition for the hydrolysis of retrograded and/or raw starch.

12. Use according to claim 11 for the removal of starch-containing stains and soils, and upon formulation into a laundry composition, for excellent whiteness maintenance and dingy cleaning.
